(19) United States
(12) Patent Application Publication
(10) Pub. No.: US 2026/0268549 A1
(43) Pub. Date: Sep. 10, 2026

(54) METHODS AND SYSTEMS FOR SPACE SEGMENTATION OR ORGANIZATION

(71) Applicant: Jacqueline M. Levin, Laguna Niguel, CA (US)

(72) Inventor: Jacqueline M. Levin, Laguna Niguel, CA (US)

(21) Appl. No.: 18/896,466

(22) PCT Filed: Nov. 6, 2023
(86) PCT No.: PCT/US2023/078787

§ 371 Date: Sep. 25, 2024

Related U.S. Application Data
(60) Provisional application No. 63/422,697, filed on Nov. 4, 2022.

(51) Int. Cl. G06T 11/60; G06Q 30/0601; G06V 10/70; G06V 20/60

(52) U.S. Cl. CPC G06T 11/60; G06Q 30/0621; G06V 10/70; G06V 20/60; G06T 2200/24

(57) ABSTRACT

Described are methods and systems for segmenting or organizing drawer space. Methods and systems may: determine drawer attributes of drawers; obtain user criteria for segmenting or organizing space within drawers; perform searches in databases or on the web based on drawer attributes and user criteria to identify bins with bin attributes that match drawer attributes and user criteria; generate layout configuration options of bins for segmenting or organizing space within drawers; and provide layout configuration options on a graphical user interface (GUI) to a user allowing the user to select, manipulate, or modify layout configuration options to achieve an optimal layout configuration option for segmenting or organizing space within drawers.

### PRIORITY CLAIM

This application claims priority to and the benefit of provisional U.S. Patent Application No. 63/422,697, filed Nov. 4, 2022, entitled “Methods and Systems for Space Segmentation or Organization,” the entire contents of which are incorporated herein by reference and relied upon.

### BACKGROUND

A consumer may need to organize spaces. For example, the consumer may want to use bins to organize clothes in drawers of a bedroom dresser. Unfortunately, methods for selecting bins to organize spaces in drawers are too difficult. The consumer may need to generate time-consuming and inaccurate measurements of the drawers. The consumer may need to perform complex calculations with seemingly innumerable possibilities for segmenting the drawers. The consumer may need to conduct exhaustive searches for bins to determine which bins can fit in the drawers. The consumer may be confronted with searches showing bins in uncountable combinations of sizes, prices, structures, materials, colors, or shapes. The consumer may be further inconvenienced when, after selecting, ordering, and receiving bins, the consumer must return the bins because they don't fit inside the drawers in a way the consumer wanted.

For at least these reasons, better methods and systems are needed for selecting organizing products (e.g., bins, trays, and the like) to use when segmenting or organizing spaces (e.g., spaces in drawers, cabinets, shelves, and the like).

### SUMMARY

Example methods and systems are disclosed for space segmentation or organization, in particular segmentation or organization of drawer space. The disclosed methods and systems address at least the issues described above, for example, by generating drawer layout configurations for a consumer. The generated layout configurations may be based on and utilize bins which are available for a consumer to purchase at a retailer. The generated layout configurations may further be based on drawer attributes, bin attributes, and/or user criteria. The example methods and systems disclosed herein may utilize a trained machine learning (ML) model to determine layout configuration options, where the trained ML model is trained using features associated with the drawer attributes, the bin attributes, the user criteria, or any combination thereof.

Aspects of the subject matter described herein may be useful alone or in combination with one or more other aspects described herein. Without limiting the foregoing description, in a first aspect of the present disclosure, which may be combined with any other aspect listed herein unless specified otherwise, a method for segmenting or organizing drawer space includes: (a) determining one or more drawer attributes of at least one drawer; (b) obtaining user criteria for segmenting or organizing a space within the at least one drawer; (c) performing a search in a database and/or on a web based at least in part on the one or more drawer attributes and the user criteria, wherein the search is performed to identify one or more bins comprising one or more bin attributes that match the one or more drawer attributes and the user criteria; (d) generating one or more layout configuration options of the one or more bins for segmenting or organizing the space within the at least one drawer; and (e) providing the one or more layout configuration options on a graphical user interface (GUI) to a user, wherein the GUI allows the user to select, manipulate, and/or modify the one or more layout configuration options, to achieve a target, desired or optimal layout configuration option for segmenting or organizing the space within the at least one drawer.

In accordance with a second aspect of the present disclosure, which may be used in combination with the first aspect, determining the one or more drawer attributes of the at least one drawer is based on processing one or more images of the at least one drawer.

In accordance with a third aspect of the present disclosure, which may be used in combination with any one or more of the preceding aspects, operations (a)-(e) are performed using one or more computing systems.

In accordance with a fourth aspect of the present disclosure, which may be used in combination with any one or more of the preceding aspects, the one or more computing systems comprise one or more cloud computing systems.

In accordance with a fifth aspect of the present disclosure, which may be used in combination with any one or more of the preceding aspects, operations (a)-(e) are performed using one or more trained machine learning algorithms.

In accordance with a sixth aspect of the present disclosure, which may be used in combination with any one or more of the preceding aspects, the drawer attributes of the at least one drawer comprise spatial dimensions, structures, materials, colors, shapes, relationships to other drawers, or any combination thereof.

In accordance with a seventh aspect of the present disclosure, which may be used in combination with any one or more of the preceding aspects, the spatial dimensions comprise one dimension, two dimensions, or three dimensions of the at least one drawer.

In accordance with an eighth aspect of the present disclosure, which may be used in combination with any one or more of the preceding aspects, the spatial dimensions comprise length, width, depth, or height of the at least one drawer.

In accordance with a ninth aspect of the present disclosure, which may be used in combination with any one or more of the preceding aspects, the structures comprise stackable storage drawers, rolling storage drawers, storage cabinets with drawers, storage dressers with drawers, beds with storage drawers, benches with drawers, filing cabinets drawers, furniture with drawers, any other system having drawers, or any combination thereof.

In accordance with a tenth aspect of the present disclosure, which may be used in combination with any one or more of the preceding aspects, the materials comprise woods, wood composites, metals, plastics, fabrics, or any combination thereof of the at least one drawer.

In accordance with an eleventh aspect of the present disclosure, which may be used in combination with any one or more of the preceding aspects, the colors comprise wavelengths of infrared (IR), visible, ultraviolet (UV) wavelengths, or any combination thereof of the at least one drawer.

In accordance with a twelfth aspect of the present disclosure, which may be used in combination with any one or more of the preceding aspects, the shapes comprise rectangular shapes, square shapes, triangular shapes, round shapes, or any combination thereof of the at least one drawer.

In accordance with a thirteenth aspect of the present disclosure, which may be used in combination with any one or more of the preceding aspects, the relationships to other drawers comprise drawers adjacent to other drawers, drawers above other drawers, drawers below other drawers, drawers behind other drawers, drawers in front of other drawers, or any combination thereof.

In accordance with a fourteenth aspect of the present disclosure, which may be used in combination with any one or more of the preceding aspects, the one or more bin attributes of the one or more bins comprise spatial dimensions, structures, materials, colors, shapes, relationships to other bins, cost, or any combination thereof.

In accordance with a fifteenth aspect of the present disclosure, which may be used in combination with any one or more of the preceding aspects, the spatial dimensions comprise one dimension, two dimensions, or three dimensions of the one or more bins.

In accordance with a sixteenth aspect of the present disclosure, which may be used in combination with any one or more of the preceding aspects, the spatial dimensions comprise length, width, depth, or height of the one or more bins.

In accordance with a seventeenth aspect of the present disclosure, which may be used in combination with any one or more of the preceding aspects, the structures comprise bins for stackable storage drawers, rolling storage drawers, storage cabinets with drawers, storage dressers with drawers, beds with storage drawers, benches with drawers, filing cabinets drawers, furniture with drawers, any other system having drawers, or any combination thereof.

In accordance with an eighteenth aspect of the present disclosure, which may be used in combination with any one or more of the preceding aspects, the materials comprise woods, wood composites, metals, plastics, fabrics, or any combination thereof of the one or more bins.

In accordance with a nineteenth aspect of the present disclosure, which may be used in combination with any one or more of the preceding aspects, the colors comprise wavelengths of infrared (IR), visible, ultraviolet (UV) wavelengths, or any combination thereof of the one or more bins. In some cases, the one or more bins may comprise a combination of colors.

In accordance with a twentieth aspect of the present disclosure, which may be used in combination with any one or more of the preceding aspects, the shapes comprises rectangular shapes, square shapes, triangular shapes, round shapes, or any combination thereof of the one or more bins.

In accordance with a twenty-first aspect of the present disclosure, which may be used in combination with any one or more of the preceding aspects, the relationships to other bins comprise bins adjacent to other bins, bins above other bins, bins below other bins, bins behind other bins, bins in front of other bins, or any combination thereof.

In accordance with a twenty-second aspect of the present disclosure, which may be used in combination with any one or more of the preceding aspects, the generating in operation (d) further comprises using a trained machine learning (ML) model to determine the one or more layout configuration options, wherein the trained ML model has been trained using features associated with the drawer attributes, the bin attributes, the user criteria, or any combination thereof.

In accordance with a twenty-third aspect of the present disclosure, which may be used in combination with any one or more of the preceding aspects, the trained ML model has been trained with the features using supervised learning, unsupervised learning, semi-supervised learning, or any combination thereof.

In accordance with a twenty-fourth aspect of the present disclosure, which may be used in combination with any one or more of the preceding aspects, the supervised, the unsupervised, or the semi-supervised learning comprises linear regression, logistic regression, k-nearest neighbors, k-means clustering, support vector machines, artificial neural networks, decision trees, random forest, principal components analysis, or any combination thereof.

In accordance with a twenty-fifth aspect of the present disclosure, which may be used in combination with any one or more of the preceding aspects, the one or more layout configuration options depict spatial relationships of the one or more bins to the at least one drawer.

In accordance with a twenty-sixth aspect of the present disclosure, which may be used in combination with any one or more of the preceding aspects, the one or more layout configuration options depict spatial relationships of the one or more bins to other bins of the one or more bins.

In accordance with a twenty-seventh aspect of the present disclosure, which may be used in combination with any one or more of the preceding aspects, the one or more layout configuration options depict spatial relationships of the at least one drawer to other drawers of the at least one drawer.

In accordance with a twenty-eighth aspect of the present disclosure, which may be used in combination with any one or more of the preceding aspects, the one or more layout configuration options comprise a plurality of layout configuration options, the method further comprising: (a) generating a recommendation comprising a recommended layout configuration selected from among the plurality of layout configuration options; and (b) providing the recommended layout configuration on the GUI to the user.

In accordance with a twenty-ninth aspect of the present disclosure, which may be used in combination with any one or more of the preceding aspects, the one or more layout configuration options are provided in one or more reports to the user.

In accordance with a thirtieth aspect of the present disclosure, which may be used in combination with any one or more of the preceding aspects, the one or more reports comprise bin purchasing data associated with the one or more bins, wherein the data comprises purchasing sources, manufacturers, suppliers, distributers, prices, user reviews, or any combination thereof.

In accordance with a thirty-first aspect of the present disclosure, which may be used in combination with any one or more of the preceding aspects, the one or more reports comprise bin attributes data associated with the one or more bins, wherein the data comprises spatial dimensions, structures, materials, colors, shapes, cost, or any combination thereof.

In accordance with a thirty-second aspect of the present disclosure, which may be used in combination with any one or more of the preceding aspects, the one or more reports comprise bin comparison data associated with the one or more bins, wherein the data compares the one or more bins between different purchasing sources, manufacturers, suppliers, distributers, or any combination thereof.

In accordance with a thirty-third aspect of the present disclosure, which may be used in combination with any one or more of the preceding aspects, the one or more reports comprise custom bin manufacturing data associated with the one or more bins, wherein the data comprises one or more manufacturers that can manufacture the one or more bins.

In accordance with a thirty-fourth aspect of the present disclosure, which may be used in combination with any one or more of the preceding aspects, the one or more reports are shared with one or more users other than the user.

In accordance with a thirty-fifth aspect of the present disclosure, which may be used in combination with any one or more of the preceding aspects, the user criteria comprises one or more criteria associated with the one or more drawer attributes, the one or more bin attributes, or any combination thereof.

In accordance with a thirty-sixth aspect of the present disclosure, which may be used in combination with any one or more of the preceding aspects, disclosed is a computer-implemented system comprising: a digital processing device comprising at least one processor, an operating system configured to perform executable instructions, a memory, and a computer program including instructions executable by the digital processing device to create an application for segmenting or organizing drawer space, the application comprising: (a) a module determining one or more drawer attributes of at least one drawer; (b) a module obtaining user criteria for segmenting or organizing a space within the at least one drawer; (c) a module performing a search in a database and/or on a web based at least in part on the one or more drawer attributes and the user criteria, wherein the search is performed to identify one or more bins comprising one or more bin attributes that match the one or more drawer attributes and the user criteria; (d) a module generating one or more layout configuration options of the one or more bins for segmenting or organizing the space within the at least one drawer; and (e) a module providing the one or more layout configuration options on a graphical user interface (GUI) to a user, wherein the GUI allows the user to select, manipulate, and/or modify the one or more layout configuration options, to achieve a target, desired or optimal layout configuration option for segmenting or organizing the space within the at least one drawer.

In accordance with a thirty-seventh aspect of the present disclosure, which may be used in combination with any one or more of the preceding aspects, disclosed is a non-transitory computer-readable storage media encoded with a computer program including instructions executable by a processor to create an application for segmenting or organizing drawer space, the application comprising: (a) a module determining one or more drawer attributes of at least one drawer; (b) a module obtaining user criteria for segmenting or organizing a space within the at least one drawer; (c) a module performing a search in a database and/or on a web based at least in part on the one or more drawer attributes and the user criteria, wherein the search is performed to identify one or more bins comprising one or more bin attributes that match the one or more drawer attributes and the user criteria; (d) a module generating one or more layout configuration options of the one or more bins for segmenting or organizing the space within the at least one drawer; and (e) a module providing the one or more layout configuration options on a graphical user interface (GUI) to a user, wherein the GUI allows the user to select, manipulate, and/or modify the one or more layout configuration options, to achieve a target, desired or optimal layout configuration option for segmenting or organizing the space within the at least one drawer.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 depicts a flow diagram for a method for segmenting or organizing drawer space, in accordance with some embodiments;

FIG. 2 depicts a non-limiting example of a computing device configured to perform methods described herein;

FIG. 3 depicts a non-limiting example of a web or mobile application provision system configured to perform methods described herein; and

FIG. 4 depicts a non-limiting example of a cloud-based web/mobile application provision system configured to perform methods described herein.

FIG. 5 depicts a diagram of an example user input user interface, according to an example embodiment of the present disclosure.

FIG. 6 depicts a diagram of an example drawer attribute user interface, according to an example embodiment of the present disclosure.

FIG. 7 depicts a diagram of an example organization method selection user interface, according to an example embodiment of the present disclosure.

FIG. 8 depicts a diagram of an example layout selection user interface, according to an example embodiment of the present disclosure.

FIG. 9 depicts a diagram of an example bin selection user interface, according to an example embodiment of the present disclosure.

FIG. 10 depicts a diagram of an example report user interface, according to an example embodiment of the present disclosure.

FIG. 11 depicts a diagram of another example bin search user interface, according to an example embodiment of the present disclosure.

FIG. 12 depicts a flow diagram for a second method for segmenting or organizing drawer space, in accordance with some embodiments disclosed herein.

FIG. 13 depicts a flow diagram for a third method for segmenting or organizing drawer space, in accordance with some embodiments disclosed herein.

FIG. 14 depicts a flow diagram for a fourth method for segmenting or organizing drawer space, in accordance with some embodiments disclosed herein.

FIG. 15 depicts a flow diagram for a fifth method for segmenting or organizing drawer space, in accordance with some embodiments disclosed herein.

### DETAILED DESCRIPTION

Recognized herein is a need for methods for segmenting or organizing drawer space. Although methods disclosed herein describe spaces in drawers, it can be understood that spaces are not limited to spaces in drawers. For example, the user may need to segment or organize spaces in drawers, cabinets, shelves, closets, bedrooms, kitchens, bathrooms, pantries, garages, refrigerators, and the like. In some instances, the terms “space” and “drawer” may be referred to interchangeably elsewhere herein. In other instances, any of space or drawer can comprise a space (or a plurality of spaces). Although methods disclosed herein describe bins for organizing spaces, it can be understood that bins are not limited to specific organizing products. For example, the user may need to segment or organize spaces using bins, boxes, baskets, trays, and the like. In some instances, the terms “organizing product” and “bin” may be referred to interchangeably elsewhere herein. In other instances, any of organizing product or bin can comprise an organizing product (or a plurality of organizing products). Numerous variations, changes, and substitutions may occur for spaces or organizing products without departing from the disclosure.

### Drawer Attributes

In some embodiments, the drawer attributes of the at least one drawer comprise spatial dimensions, structures, materials, colors, shapes, intended content (e.g., clothing, food, etc.), intended room of use, drawer location, drawer position, relationships to other drawers, or any combination thereof. In some cases, drawer attributes may comprise drawer product data. For example, drawer product data may include data associated with a drawer from manufacturers, suppliers, distributors, sellers, or users of drawers.

In some cases, drawer product data may comprise spatial dimensions, structures, materials, colors, shapes, brands, names, prices, intended content (e.g., clothing, food, etc.), intended room of use, drawer location, drawer position, product uniform resource locators (URL), retailors, sets, codes (e.g., universal product codes (UPC), European article numbers (EAN), Amazon standard identification number (ASIN), manufacturer part number (MPN), and the like), or any combination thereof.

In some cases, drawer product data may comprise special attributes of drawers. Special attributes may include, for example, handles, open front, lid, stackable, interlocking, free-standing, modular, decorative, food safe, lined, adjustable, collapsible, machine washable, heavy duty, dishwasher safe, rolling, customizable, freezer safe, clips, interlocking, airtight, under the bed, waterproof, wall mounted, acid free, assembly required, break resistant, dry erase, gliding shelf, heat resistant, magnetic, mounted, or any combination thereof.

In some cases, drawer product data may comprise product categories (e.g., kitchen, bedroom, bathroom, garage, etc.), special functions (e.g., designed to store socks, belts, nail polish, etc.), descriptions (e.g., a textual description), variations available (e.g., color, materials, scents, spatial dimensions, counts, multipacks, etc.), available inventory, images, reviews, other attributes (e.g., sustainable, bisphenol A (BPA)-free, recycled, etc.), or any combination thereof.

In some cases, drawer attributes may be derived from drawer product data. For example, a seller of drawers may categorize a drawer in a first category (e.g., drawers for shoes), and another seller of drawers may categorize the drawer in a second category (e.g., drawers for boots). Methods disclosed herein may derive a drawer attribute that is universal from the first category and the second category (e.g., drawers for footwear). For example, a seller may categorize a drawer in a category (e.g., drawers for refrigerators). Methods disclosed herein may derive drawer attributes from the category (e.g., the refrigerator drawers may be safe for food, robust to cold temperatures or moisture, or BPA-free). For example, a seller may categorize a drawer in a category (e.g., drawers for garages). Methods described herein may derive attributes from the category (e.g., the garage drawers may be robust to cold temperatures or hot temperatures). For example, a seller may sell a drawer this is comprised of a broad material (e.g., a drawer may be comprised of wood). Methods described herein may derive narrower attributes of the material (e.g., the drawer may be comprised of maple wood).

Exampled disclosed herein may receive drawer product data from multiple sources and merge such drawer product data. For example, drawer product data from multiple sources may be merged to so as to form universal categories for drawer attributes. For example, a first category of drawer product data (e.g., drawers for shoes) and a second category of drawer product data (e.g., drawers for boots) may be merged into a universal category (e.g., drawers for footwear). For example, a seller may sell a drawer that is the same drawer from another seller. Drawer product data provided by the seller may be different than drawer product data provided the other seller, however, the drawer product data may have the same drawer attributes. Methods described herein may merge the product data of the seller and the product data of the other seller into a single set of drawer attributes.

In some cases, drawer attributes may include unique identifiers. For example, universal categories may each be assigned a unique identifier. Unique identifiers may also include a stock keeping unit (“SKU”) number, a model number, or a serial number. Unique identifiers may be stored in a database having drawer attributes, bin attributes, or user criteria for use by methods described herein.

In some cases, drawer attributes may be generated or provided by the user from the one or more images. Alternatively or additionally, drawer attributes may be generated or provided by another user from the one or more images. In some cases, drawer attributes may be generated or provided by a computing system from the one or more images. In some cases, drawer attributes may be received by a user from the one or more images. Alternatively or additionally, drawer attributes may be received by another user from the one or more images. In some cases, drawer attributes may be received by a computing system from the one or more images. Drawer attributes that are generated, provided, or rendered and/or received by a user, by another user, or by a computing system from the one or more images may be stored in a database for use by methods described herein. In some cases, drawer attributes may be used by machine learning methods described herein.

In some cases, drawer attributes may be generated from the one or more images. Drawer attributes may be generated by image processing of the one or more images. Image processing operations may include image acquisition, image enhancement, image restoration, color image processing, multi-resolution processing, image compression, morphological processing, image segmentation, representation or description, object detection or recognition, or any combination thereof. In some cases, image processing of the one or more images may be performed by a user or another user. For example, a user may use a raster graphics editor such as Adobe® Photoshop to determine drawer attributes. Alternatively or additionally, as user may use a vector graphics editor such as Adobe® Illustrator to determine drawer attributes.

In some cases, image processing of the one or more images may be performed automatically by a computing system. The computing system may perform machine learning methods to determine drawer attributes from the one or more images. For example, a user may use algorithms generated for computer vision recognition applications such as OpenCV®, Tensorflow®, PyTorch®, Caffe®, and the like.

In some embodiments, the spatial dimensions comprise one dimension, two dimensions, or three dimensions of the at least one drawer. For example, one dimension may be one of a length, width, depth, or height of the at least one drawer. Two dimensions may be two of a length, width, depth, or height of the at least one drawer. Three dimensions may be three of a length, width, depth, or height of the at least one drawer. In some cases, the spatial dimension may be a volume of space of the at least one drawer. In some cases, a user or another user may generate or provide the spatial dimensions. Alternatively or additionally, image processing may be performed to generate the spatial dimensions. In some embodiments, the spatial dimensions comprise length, width, depth, or height of the at least one drawer. In some cases, spatial dimensions include an orientation. For example, the orientation may comprise assigning a front, a top, a bottom, a side, a back, or any combination thereof of the at least one drawer. The assigning may be generated or provided.

In some embodiments, the structures comprise stackable storage drawers, rolling storage drawers, storage cabinets with drawers, storage dressers with drawers, beds with storage drawers, benches with drawers, filing cabinets drawers, furniture with drawers, any other system having drawers, or any combination thereof. In some cases, a user or another user may generate or provide the structures of the at least one drawer. For example, a user may have a storage dresser for clothing with drawers that are to be segmented or organized with one or more bins. The one or more bins may have one or more bin attributes (e.g., a bin for storing shirts) purposefully suited for the structure of the storage dresser for clothing with drawers. Alternatively or additionally, image processing may be performed to generate the structures of the at least one drawer.

In some embodiments, the materials comprise woods, wood composites, metals, plastics, fabrics, or any combination thereof of the at least one drawer. In some cases, a user or another user may generate or provide the materials of the at least one drawer. For example, a user may have a wooden bench with wooden drawers that are to be segmented or organized with one or more bins. The one or more bins may have one or more bin attributes (e.g., a wooden bin) purposefully suited for the structure of the wooden bench with wooden drawers. Alternatively or additionally, image processing may be performed to generate the materials of the at least one drawer.

In some embodiments, the colors comprise wavelengths of infrared (IR), visible, ultraviolet (UV) wavelengths, or any combination thereof of the at least one drawer. In some cases, a user or another user may generate or provide the colors of the at least one drawer. For example, a user may have brown furniture with grey drawers that are to be segmented or organized with one or more bins. The one or more bins may have one or more bin attributes (e.g., a bin color that complements the brown furniture or grey drawers) purposefully suited for the brown furniture with grey drawers. Alternatively or additionally, image processing may be performed to generate the colors of the at least one drawer. In some cases, imaging image may be performed to match one or more colors of the at least one drawer to the one or more bins.

In some embodiments, the shapes comprise rectangular shapes, square shapes, triangular shapes, round shapes, or any combination thereof of the at least one drawer. In some cases, a user or another user may generate or provide the shapes of the at least one drawer. For example, a user may have nonstandard triangular stackable storage drawers that are to be segmented or organized with one or more bins. The one or more bins may have one or more bin attributes (e.g., a triangular bin shape) purposefully suited for the nonstandard triangular stackable storage drawers. Alternatively or additionally, image processing may be performed to generate the shapes of the at least one drawer.

In some embodiments, the relationships to other drawers comprise drawers adjacent to other drawers, drawers above other drawers, drawers below other drawers, drawers behind other drawers, drawers in front of other drawers, or any combination thereof. In some cases, a user or another user may generate or provide the relationships of the at least one drawer to other drawers. For example, a user may have a filing cabinet with deep drawers that are to be segmented or organized with one or more bins. The filing cabinet may have six total deep drawers spatially arranged as three rows of drawers by two columns of drawers. The one or more bins may have one or more bin attributes (e.g., a tall bin) purposefully suited for the filing cabinet having six total deep drawers. Alternatively or additionally, image processing may be performed to generate the relationships of the at least one drawer to other drawers. In some cases, the relationships may comprise relationships of drawers to other than drawers. For example, a drawer may be in a cabinet of a kitchen located near a permanent fixture such as a refrigerator, a stove, a microwave, and the like. A drawer may not be located near or at the one or more permanent fixtures. In some cases, the relationships may comprise relationships of drawers to other existing drawers. A drawer may not be located near or at the existing drawer.

### Drawer Images

In some cases, the one or more images may be generated or provided by the user. Alternatively or additionally, the one or more images may be generated or provided by another user. For example, the user may generate the one or more images of the at least one drawer using an image capture device. Alternatively or additionally, the user may provide the one or more images. The one or more images may comprise at least about 1, 2, 3, 4, 5, 6 or more images. The one more or more images may include at most about 6, 5, 4, 3, 2, or less images. The one or more images may include one or more perspectives of the at least one drawer. For example, the one or more perspectives may comprise an image of a drawer from above the drawer, from below the drawer, from each side of a drawer, from any angle of the drawer, or any combination thereof.

An image capture device may include a digital image capture device. The digital image capture device may generate a still image (e.g., a photograph) or a moving image (e.g., a movie). Nonlimiting examples of digital image capture devices may include, for example, a digital single-lens reflex (DSLR) camera, a digital point and shoot camera, a bridge camera, a camera phone, a compact camera, a rugged compact camera, an action camera, a 360 degree camera, a mirrorless interchangeable-lens camera, a modular camera, a digital still camera, a rangefinder camera, a line-scan camera, or any combination thereof. The one or more images captured by a digital image capture device may be converted to one or more other digital images for use by methods described herein.

An image capture device may include an analog image capture device. The analog image capture device may generate a still image (e.g., a photograph) or a moving image (e.g., a movie). Nonlimiting examples of analog image capture devices may include, for example, a single-lens reflex (SLR) camera, a twin-lens reflex (TLR) camera, a rangefinder camera, a point-and-shoot camera, an instant camera, a stereo camera, a panoramic camera, a folding camera, a large format camera, a box camera, a pinhole camera, a toy camera, or any combination thereof. The one or more images captured by an analog image capture device may be converted to one or more digital images for use by methods described herein.

An image capture device may include an analog scan or a digital scan of one or more sketches of the at least one drawer. The one or more sketches may be generated or provided by the user or generated or provided by another user. In some examples, the one or more sketches include one or more spatial dimensions of the at least one drawer. In some examples, the one or more sketches do not include spatial dimensions of the at least one drawer. The one or more sketches of the at least one drawer may be drawn to scale. In some examples, the one or more sketches of the at least one drawer are not be drawn to scale. The one or more images captured by an analog scan may be converted to one or more digital images for use by methods described herein. The one or more images captured by a digital scan may be converted to one or more other digital images for use by methods described herein.

### Bin Attributes

In some embodiments, bin attributes may describe characteristics of a bin. Example bin attributes may be assigned bin attributes which may be assigned to a bin based on the characteristics of a commercially available bin. Other example bin attributes may be desired bin attributes. Desired bin attributes may correspond to characteristics of bins which are desirable to a user. In some examples, desired bin attributes may correspond to characteristics of bins which are suitable for use with the corresponding drawer. In some examples, the desired bin attributes are provided as user inputs. In some examples, the desired bin attributes are determined based on drawer attributes. In some examples, desired bin attributes are determined based on user inputs and/or drawer attributes.

In some embodiments, the one or more bin attributes of the one or more bins comprise spatial dimensions, structures, materials, colors, shapes, relationships to other bins, cost, or any combination thereof. In some cases, assigned bin attributes may comprise bin product data. For example, bin product data may include data associated with a bin from manufacturers, suppliers, distributors, sellers, or users of bins.

In some cases, bin product data may comprise spatial dimensions, structures, materials, colors, shapes, brands, names, prices, intended content (e.g., clothing, food, etc.), product uniform resource locators (URL), retailors, sets, codes (e.g., UPC, EAN, ASIN, MPN, and the like), or any combination thereof.

In some cases, bin product data may comprise special attributes of bins. Special attributes may include, for example, handles, open front, lid, stackable, interlocking, free-standing, modular, decorative, food safe, lined, adjustable, collapsible, machine washable, heavy duty, dishwasher safe, rolling, customizable, freezer safe, clips, interlocking, airtight, under the bed, waterproof, wall mounted, acid free, assembly required, break resistant, dry erase, gliding shelf, heat resistant, magnetic, mounted, or any combination thereof.

In some cases, bin product data may comprise product categories (e.g., kitchen, bedroom, bathroom, garage, etc.), special functions (e.g., designed to store socks, belts, nail polish, etc.), descriptions (e.g., a textual description), variations available (e.g., color, materials, scents, spatial dimensions, counts, multipacks, etc.), available inventory, images, reviews, other attributes (e.g., sustainable, BPA-free, recycled, etc.), or any combination thereof.

In some cases, assigned bin attributes may be derived from bin product data. For example, a seller of bins may categorize a bin in a first category (e.g., bins for shoes), and another seller of bins may categorize the bin in a second category (e.g., bins for boots). Methods disclosed herein may derive a bin attribute that is universal from the first category and the second category (e.g., bins for footwear). For example, a seller may categorize a bin in a category (e.g., bins for refrigerators). Methods disclosed herein may derive bin attributes from the category (e.g., the refrigerator bins may be safe for food, robust to cold temperatures or moisture, or bisphenol A (BPA)-free). For example, a seller may categorize a bin in a category (e.g., bins for garages). Methods described herein may derive attributes from the category (e.g., the garage bins may be robust to cold temperatures or hot temperatures). For example, a seller may sell a bin this is comprised of a broad material (e.g., a bin may be comprised of wood). Methods described herein may derive narrower attributes of the material (e.g., the bin may be comprised of maple wood).

Examples disclosed herein may receive bin product data from multiple sources and merge such bin product data. For example, bin product data from multiple sources may be merged so as to form universal categories for bin attributes. For example, a first category of bin product data (e.g., bins for shoes) and a second category of bin product data (e.g., bins for boots) may be merged into a universal category (e.g., bins for footwear). For example, a seller may sell a bin that is the same bin from another seller. Bin product data provided by the seller may be different than bin product data provided the other seller, however, the bin product data may have the same bin attributes. Methods described herein may merge the product data of the seller and the product data of the other seller into a single set of bin attributes.

In some cases, bin attributes may include unique identifiers. For example, universal categories may each be assigned a unique identifier. Unique identifiers may be stored in a database having drawer attributes, bin attributes, or user criteria for use by methods described herein.

In some cases, desired bin attributes may be generated or provided by the user. Alternatively or additionally, desired bin attributes may be generated or provided by another user. In some cases, desired bin attributes may be generated or provided by a computing system. In some cases, desired bin attributes may be received by a user. Alternatively or additionally, desired bin attributes may be received by another user. In some cases, bin attributes may be received by a computing system.

In some cases, desired bin attributes may be determined based on drawer attributes and/or user inputs. In some examples, one or more drawer attributes may indicate suitable desired bin attributes. As described above, such drawer attributes may be determined based on user inputs and/or drawer product data. For example, if the intended room of use for a drawer is a kitchen, this drawer attribute may indicate that a desired bin attribute is a material that is food safe. In another example, if the intended content for a drawer is shirts, desired bin attributes may include spatial dimensions suitable for containing a shirt. In some examples, desired bin attributes determined based on drawer attributes may be combined with desired bin attributes based on user inputs. In some examples, a user may modify desired bin attributes that were determined based on drawer attributes.

Bin attributes that are generated, provided, or received by a user, by another user, or by a computing system may be stored in a database for use by methods described herein. In some cases, bin attributes may be used by machine learning methods described herein.

In some cases, the computing system may be configured to perform machine learning methods. The machine learning methods may be trained using features associated with drawer attributes, bin attributes, user criteria, or any combination thereof. The machine learning methods may identify or predict the one or more bins having bin attributes that match the one or more drawer attributes and user criteria. The machine learning methods may identify or predict with a confidence level. The confidence level may be at least about 60%, 70%, 80%, 90%, or better.

In some embodiments, the spatial dimensions comprise one dimension, two dimensions, or three dimensions of the one or more bins. For example, one dimension may be one of a length, width, depth, or height of the one or more bins. Two dimensions may be two of a length, width, depth, or height of the one or more bins. Three dimensions may be three of a length, width, depth, or height of the one or more bins. In some cases, the spatial dimension may be a volume of space of the one or more bins. In some cases, a user or another user may generate or provide the spatial dimensions. Alternatively or additionally, a computing system may be configured to perform machine learning methods to generate the spatial dimensions for one or more layout configuration options of the one or more drawers. In some embodiments, the spatial dimensions comprise length, width, depth, or height of the one or more bins. In some cases, spatial dimensions include an orientation. For example, the orientation may comprise assigning a front, a top, a bottom, a side, a back, or any combination thereof of the one or more bins. The assigning may be generated or provided.

In some embodiments, the structures comprise bins for stackable storage drawers, bins for rolling storage drawers, bins for storage cabinets with drawers, bins for storage dressers with drawers, bins for beds with storage drawers, bins for benches with drawers, bins for filing cabinets drawers, bins for furniture with drawers, bins for any other system having drawers, or any combination thereof. In some cases, the one or more bins may comprise a combination of structures. For example, a bin may comprise structures suitable for use in outdoor and indoor storage drawer systems. As described elsewhere herein, the one or more bins may have bin attributes (e.g., structures) purposefully suited for drawer attributes comprising spatial dimensions, structures, materials, colors, shapes, or relationships to other drawers. In some cases, the one or more bins may have bin attributes (e.g., structures) that are not purposefully suited for the at least one drawer. For example, a user may choose a bin structure (e.g., a bin for a filing cabinet drawer) for a drawer in a refrigerator. However, the bin structure may still satisfy user criteria. In some cases, bin structure may be generated or provided by a user. Alternatively or additionally, bin structure may be generated or provided by another user. In some cases, bin structure may be generated by a computing system configured to perform machine learning methods to identify or predict the one or more bins having bin structures that match the one or more drawer attributes and user criteria with a confidence level.

In some embodiments, the materials comprise woods, wood composites, metals, plastics, fabrics, or any combination thereof of the one or more bins. In some cases, the one or more bins may comprise a combination of materials. For example, a bin may be constructed of wood and plastic. As described elsewhere herein, the one or more bins may have bin attributes (e.g., materials) purposefully suited for drawer attributes comprising spatial dimensions, structures, materials, colors, shapes, or relationships to other drawers. In some cases, the one or more bins may have bin attributes (e.g., materials) that are not purposefully suited for the at least one drawer. For example, a user may choose a bin material (e.g., a metal bin susceptible to rusting) for a drawer in an outdoor drawer storage system that may prescribe a bin material that is rust-proof. However, the bin material may still satisfy user criteria. In some cases, bin material may be generated or provided by a user. Alternatively or additionally, bin material may be generated or provided by another user. In some cases, bin material may be generated by a computing system configured to perform machine learning methods to identify or predict the one or more bins having bin materials that match the one or more drawer attributes and user criteria with a confidence level.

In some embodiments, the colors comprise wavelengths of infrared (IR), visible, ultraviolet (UV) wavelengths, or any combination thereof of the one or more bins. In some cases, the one or more bins may comprise a combination of colors. For example, a bin may have visible colors (e.g., green viewable in light conditions via a user's eyes) and IR colors (e.g., IR wavelengths viewable in nonlight conditions via an IR detector). As described elsewhere herein, the one or more bins may have bin attributes (e.g., colors) purposefully suited for drawer attributes comprising spatial dimensions, structures, materials, colors, shapes, or relationships to other drawers. In some cases, the one or more bins may have bin attributes (e.g., colors) that are not purposefully suited for the at least one drawer. For example, a user may choose a bin color (e.g., a green bin) for a drawer having a color that may not complement the bin color (e.g., a green bin may not complement an orange drawer). However, the bin color may still satisfy user criteria. In some cases, bin color may be generated or provided by a user. Alternatively or additionally, bin color may be generated or provided by another user. In some cases, bin color may be generated by a computing system configured to perform machine learning methods to identify or predict the one or more bins having bin colors that match the one or more drawer attributes and user criteria with a confidence level.

In some embodiments, the shapes comprises rectangular shapes, square shapes, triangular shapes, round shapes, or any combination thereof of the one or more bins. In some cases, the one or more bins may comprise a combination of shapes. For example, a bin may have a rectangular portion and another circular portion. As described elsewhere herein, the one or more bins may have bin attributes (e.g., shapes) purposefully suited for drawer attributes comprising spatial dimensions, structures, materials, colors, shapes, or relationships to other drawers. In some cases, the one or more bins may have bin attributes (e.g., shapes) that are not purposefully suited for the at least one drawer. For example, a user may choose a bin shape (e.g., a round bin) for a square drawer of a rolling storage drawer system that may not optimize space within the drawer. However, the bin shape may still satisfy user criteria. In some cases, bin shape may be generated or provided by a user. Alternatively or additionally, bin shape may be generated or provided by another user. In some cases, bin shape may be generated by a computing system configured to perform machine learning methods to identify or predict the one or more bins having bin shapes that match the one or more drawer attributes and user criteria with a confidence level.

In some embodiments, the relationships to other bins comprise bins adjacent to other bins, bins above other bins, bins below other bins, bins behind other bins, bins in front of other bins, or any combination thereof. In some cases, the one or more bins may comprise a combination of relationships to other bins. For example, a first bin may be located adjacent to a second bin and in front of a third bin. As described elsewhere herein, the one or more bins may have bin attributes (e.g., relationships to other bins) purposefully suited for drawer attributes comprising spatial dimensions, structures, materials, colors, shapes, or relationships to other drawers. In some cases, the one or more bins may have bin attributes (e.g., relationships to other bins) that are not purposefully suited for the at least one drawer. For example, a user may choose a bin relationship (e.g., a bin adjacent to another bin with a space or gap between the bins) for a drawer of a bed with storage drawers that may not optimize space within the drawer. However, the bin relationship may still satisfy user criteria. For example, the user may prefer a space or a gap between bins that may not optimize free space between bins (e.g., optimizing free space may include determining a space or gap between the one or more bins that is smaller than preferred by the user).

In some cases, bin relationships may be generated or provided by a user. Alternatively or additionally, bin relationships may be generated or provided by another user. In some cases, bin relationships may be generated by a computing system configured to perform machine learning methods to identify or predict the one or more bins having relationships to other bins that match the one or more drawer attributes and user criteria with a confidence level. In some cases, the relationships may comprise relationships of bins to other than bins. For example, a bin may be in a television stand of a family room located near a permanent fixture such as a television, a video recorder, speakers, and the like. A bin may not be located near or at the one or more permanent fixtures. In some cases, the relationships may comprise relationships of bins to other existing bins. A bin may not be located near or at the existing bin.

### User Criteria

Methods described herein may perform a search in a database and/or on a web based at least in part on drawer attributes, bin attributes, user criteria, or any combination thereof. The search may identify one or more bins having bin attributes that match drawer attributes and user criteria.

In some embodiments, the user criteria comprises one or more criteria associated with the one or more drawer attributes, the one or more bin attributes, or any combination thereof. In some cases, user criteria comprises criteria associated with drawer attributes. In some cases, user criteria may be associated with one or more users. Users may include, for example, purchasing sources, manufacturers, suppliers, distributers, other users, or any combination thereof. User criteria may include, for example, spatial dimensions, structures, materials, colors, shapes, or relationships to other drawers, or any combination thereof. User criteria may comprise preferred criteria for none, some, or all drawer attributes.

User criteria may include, for example, criteria associated with locations of drawers (e.g., drawers for dresser 1 located in bedroom 1), numbers of drawers (e.g., dresser 1 in bedroom 1 may have 6 drawers), preferred numbers of drawers (e.g., dresser 1 in bedroom 1 may have 6 drawers and the user desires bins for 2 of the drawers), drawer names (e.g., drawer 1 and drawer 2 of dresser 1 in bedroom 1), locations of preferred drawers (e.g., drawer 1 located at top of dresser 1 in bedroom 1 and drawer 2 located at bottom of dresser 1 in bedroom 1), drawer items (e.g., ties to be stored in drawer 1 and pants to be stored in drawer 2 of dresser 1 in bedroom 1), numbers of drawer items (e.g., 10 ties to be stored in drawer 1 and 5 pants to be stored in drawer 2), sizes of drawer items (e.g., ties in drawer 1 have sizes and pants in drawer 2 have sizes), preferred purchasing sources, preferred manufacturers, preferred suppliers, or preferred distributors. User criteria may include, for example, drawers having same sizes or drawers have different sizes.

In some cases, user criteria comprises criteria associated with bin attributes. In some cases, user criteria may be associated with one or more users. Users may include, for example, purchasing sources, manufacturers, suppliers, distributers, other users, or any combination thereof. User criteria may include, for example, spatial dimensions, structures, materials, colors, shapes, or relationships to other bins, or any combination thereof. User criteria may comprise preferred criteria for none, some, or all bin attributes.

User criteria may include, for example, criteria associated with locations of bins (e.g., bins for cabinet 1 located in bathroom 1), numbers of bins (e.g., cabinet 1 in bathroom 1 may need 2 bins), preferred numbers of bins (e.g., cabinet 1 in bathroom 1 may accommodate 6 bins and the user desires 2 bins), bin names (e.g., bin 1 and bin 2 of cabinet 1 in bathroom 1), locations of preferred bins (e.g., bin 1 located on top shelf of cabinet 1 and bin 2 located on bottom shelf of cabinet 1 in bathroom 1), bin items (e.g., hair dryer to be stored in bin 1 and cleaning supplies to be stored in bin 2 of cabinet 1 in bathroom 1), numbers of bin items (e.g., 1 hairdryer to be stored in bin 1 and 3 cleaning supplies to be stored in bin 2), sizes of bin items (e.g., hairdryer in bin 1 has a size and cleaning supplies in bin 2 have sizes), preferred purchasing sources, preferred manufacturers, preferred suppliers, or preferred distributors. User criteria may include, for example, bins having same sizes or bins have different sizes.

In some cases, user criteria may be associated with a user profile. For example, a user profile may include personal data (e.g., username, user address, user contact, and the like). In some cases, user criteria may be associated with other user profiles. Other users may include, for example, purchasing sources, manufacturers, suppliers, distributers, other users, or any combination thereof. User profiles of other users may include personal data (e.g., username, user address, user contact, and the like).

In some cases, a user may generate or provide user criteria for use by methods described herein. For example, the user may generate or provide user criteria associated with drawer attributes, bin attributes, user criteria, or any combination thereof via one or more questionnaires. The questionnaires may query the user using a set of questions. The set of questions may be textual, visual, graphical, or any combination thereof. In some cases, the set of questions may have a first set of questions and a second set of questions. The second set of questions may change or update due to answers the user generates or provides for the first set of questions. In some cases, user criteria may be received for use by methods described herein.

In some cases, the user may generate or provide user criteria associated with drawer attributes, bin attributes, user criteria, or any combination thereof via natural language processing. A computing system configured to perform natural language processing may process one or more textual or audible inputs from the user. The computing system may determine drawer attributes, bin attributes, or user criteria from the processing. For example, the user might say, “I need to organize my clothes so they are easier to access.” The computing system configured to perform natural language processing can process the user's statement. The computing system may determine drawer attributes (e.g., drawers for dressers in bedrooms), bin attributes (e.g., bins having sizes, shapes, or materials for shirts, pants, and the like), or user criteria (e.g., a preferred spacing between bins that may not be optimal) based on the user's statement. In some cases, user criteria may be received after processing by a computing system configure to perform natural language processing.

In some cases, the trained ML model may use user criteria as features to generate one or more layout configuration options of the one or more bins for segmenting or organizing the space within the at least one drawer.

### Layout Configurations

In some embodiments, the generating in operation (d) further comprises using a trained machine learning (ML) model to determine the one or more layout configuration options, wherein the trained ML model has been trained using features associated with the drawer attributes, the bin attributes, the user criteria, or any combination thereof. In some cases, the trained ML model may determine at least about 1, 2, 3, 4, 5, or more layout configuration options. In some cases, the trained ML model may determine at most about 5, 4, 3, 2, or less layout configuration options.

In some cases, the features may be the drawer attributes described elsewhere herein. In some cases, the features may be a combination of the drawer attributes and features derived from drawer attributes. In some cases, the features may be derived from drawer attributes. In some cases, the trained ML model may be trained with at least about 1, 2, 3, 4, 5, or more features associated with drawer attributes. In some cases, the trained ML model may be trained with at most about 5, 4, 3, 2, or less features associated with drawer attributes.

In some cases, the features may be the bin attributes described elsewhere herein. In some cases, the features may be a combination of the bin attributes and features derived from bin attributes. In some cases, the features may be derived from bin attributes. In some cases, the trained ML model may be trained with at least about 1, 2, 3, 4, 5, or more features associated with bin attributes. In some cases, the trained ML model may be trained with at most about 5, 4, 3, 2, or less features associated with bin attributes.

In some cases, the features may be user criteria. In some cases, the features may be a combination of user criteria and features derived from user criteria. In some cases, the features may be derived from user criteria. In some cases, the trained ML model may be trained with at least about 1, 2, 3, 4, 5, or more features associated with user criteria. In some cases, the trained ML model may be trained with at most about 5, 4, 3, 2, or less features associated with user criteria.

In some embodiments, the trained ML model has been trained with the features using supervised learning, unsupervised learning, semi-supervised learning, or any combination thereof. In some embodiments, the supervised, the unsupervised, or the semi-supervised learning comprises linear regression, logistic regression, k-nearest neighbors, k-means clustering, support vector machines, artificial neural networks, decision trees, random forest, principal components analysis, or any combination thereof. In some cases, the trained ML model may be trained with features using supervised learning to segment or organize drawer space and generate one or more layout configuration options.

For example, the trained ML model may be trained using supervised learning with a training set of data. In some cases, the training set of data may be labeled. In some cases, the training set of data may not be labeled. In some cases, the training set of data may include a first set of training data that is labeled and a second set of training data that is not be labeled. In some cases, a training set of data may include drawer attributes of at least one drawer that are labeled. Labeling may include labels associated with drawer attributes. Drawer attributes may be associated with one or more images of drawers. Drawer attributes may be associated with one or more textual descriptions of drawers (e.g., product data provided by a manufacturer, supplier, distributor, seller, or user). Alternatively or additionally, drawer attributes may be associated with one or more images of drawers or one or more textual descriptions of drawers. For example, the one or more images of drawers may be images associated with a drawer structure (e.g., storage dressers with drawers). The storage dresser with drawers may include additional drawer attributes of spatial dimensions, materials, colors, shapes, relationships to other drawers, or any combination thereof. For example, the one or more images of the storage dressers with drawers may be labeled with: spatial dimensions (e.g., a medium drawer having dimensions 28 inches in width, 16 inches in depth, and 6 inches in height), a material (e.g., wood composite), a color (e.g., brown), a shape (e.g., rectangular), or relationships to other drawers (e.g., the storage dresser may have six total drawers spatially arranged as three rows of drawers by two columns of drawers).

In some cases, a training set of data may include bin attributes of one or more bins. Labeling may include labels associated with bin attributes. Bin attributes may be associated with one or more images of bins. Bin attributes may be associated with one or more textual descriptions of bins (e.g., product data provided by a manufacturer, supplier, distributor, seller, or user). Alternatively or additionally, bin attributes may be associated with one or more images of bins or one or more textual descriptions of bins. For example, the one or more textual descriptions of bins may be textual descriptions associated with a bin structure (e.g., bins for kitchen drawers). The bins for kitchen drawers may include additional bin attributes of spatial dimensions, materials, colors, shapes, relationships to other bins, or any combination thereof. For example, the one or more textual descriptions of bins for kitchen drawers may be labeled with: spatial dimensions (e.g., a bin for kitchen utensils having dimensions 3 inches in width, 6 inches in depth, and 2 inches in height), a material (e.g., plastic), a color (e.g., optically clear or transparent), a shape (e.g., rectangular), or relationships to other bins (e.g., the kitchen drawer may have 3 total bins spatially arranged as 1 row of bins by three columns of bins for storing knives, spoons, and forks).

In some cases, a training set of data may include user criteria. Labeling may include labels associated with one or more previous user criteria. Bin attributes may be associated with one or more images of bins. Bin attributes may be associated with one or more textual descriptions of bins (e.g., product data received from a manufacturer, supplier, distributor, seller, or user). Alternatively or additionally, bin attributes may be associated with one or more images of bins or one or more textual descriptions of bins. For example, the one or more textual descriptions of bins may be textual descriptions associated with a bin structure (e.g., bins for kitchen drawers). The bins for kitchen drawers may include additional bin attributes of spatial dimensions, materials, colors, shapes, relationships to other bins, or any combination thereof. For example, the one or more textual descriptions of bins for kitchen drawers may be labeled with: spatial dimensions (e.g., a bin for kitchen utensils having dimensions 3 inches in width, 6 inches in depth, and 2 inches in height), a material (e.g., plastic), a color (e.g., optically clear or transparent), a shape (e.g., rectangular), or relationships to other bins (e.g., the kitchen drawer may have 3 total bins spatially arranged as 1 row of bins by three columns of bins for storing knives, spoons, and forks).

In some embodiments, the one or more layout configuration options depict spatial relationships of the one or more bins to the at least one drawer.

In some embodiments, the one or more layout configuration options depict spatial relationships of the one or more bins to other bins of the one or more bins. In some cases, the one or more bins may be in contact with other bins. For example, a bin may be in contact with another bin along or partially along one edge, two edges, three edges, four edges, or more. For example, a bin may be in contact with another bin along or partially along one surface, two surfaces, three surfaces, four surfaces, or more. Alternatively or additionally, a bin may be in contact with another bin along one or more edges or along one or more surfaces. In some cases, the one or more bins may not be in contact with another bin. For example, a bin may be spatially separated (e.g., a gap) from another bin. The spatial separation may be uniform along the separation. The spatial separation may not be uniform along the separation. Alternatively or additionally, the spatial separation may be uniform along a portion of the separation and not uniform along another portion of the separation. In some cases, a user may prefer a space or a gap between bins that may not optimize free space between bins (e.g., optimizing free space may include determining a minimum space or gap between the one or more bins).

In some cases, the spatial separation may be in combination with one or more orientations (e.g., assigning a front, a back, a top, a bottom, a side, etc.) of the one or more bins. For example, a bin may have an open front side (e.g., a material that is optically transparent to see through, a material that is removable such as a cover, or a side having no material) wherein a user may access (e.g., see through the material or reach through the side) a space within the bin through the open front side. The spatial separation from another bin may ensure access to the space within the bin through the open front side. For example, a bin may have an open top side (e.g., a material that is optically transparent to see through, a material that is removable such as a lid, or a side having no material) wherein a user may access (e.g., see through the material or reach through the side) a space within the bin through the open top side. The spatial separation from another bin may ensure access to the space within the bin through the open top side. In some cases, the trained ML model may use the one or more spatial separations or the one or more orientations to generate one or more layout configuration options of the one or more bins for segmenting or organizing the space within the at least one drawer.

In some embodiments, the one or more layout configuration options depict spatial relationships of the at least one drawer to other drawers of the at least one drawer. In some cases, the at least one drawers may be in contact with other drawers. For example, a drawer may be in contact with another drawer along or partially along one edge, two edges, three edges, four edges, or more. For example, a drawer may be in contact with another drawer along or partially along one surface, two surfaces, three surfaces, four surfaces, or more. Alternatively or additionally, a drawer may be in contact with another drawer along one or more edges or along one or more surfaces. In some cases, the at least one drawer may not be in contact with another drawer. For example, a drawer may be spatially separated (e.g., a gap) from another drawer. The spatial separation may be uniform along the separation. The spatial separation may not be uniform along the separation. Alternatively or additionally, the spatial separation may be uniform along a portion of the separation and not uniform along another portion of the separation. In some cases, a user may prefer a space or a gap between drawers that may not optimize free space between drawers (e.g., optimizing free space may include determining a minimum space or gap between drawers of the at least one drawer). In some cases, the trained ML model may use the one or more spatial separations as features to generate one or more layout configuration options of the one or more bins for segmenting or organizing the space within the at least one drawer.

In some embodiments, the one or more layout configuration options depict spatial relationships of the one or more bins to other bins of the at least one drawer. In some cases, the one or more bins may be in contact with other bins. For example, a bin may be in contact with another bin along or partially along one edge, two edges, three edges, four edges, or more. For example, a bin may be in contact with another bin along or partially along one surface, two surfaces, three surfaces, four surfaces, or more. Alternatively or additionally, a bin may be in contact with another bin along one or more edges or along one or more surfaces. In some cases, the at least one bin may not be in contact with another bin. For example, a bin may be spatially separated (e.g., a gap) from another bin. The spatial separation may be uniform along the separation. The spatial separation may not be uniform along the separation. Alternatively or additionally, the spatial separation may be uniform along a portion of the separation and not uniform along another portion of the separation. In some cases, a user may prefer a space or a gap between bins that may not optimize free space between bins (e.g., optimizing free space may include determining a minimum space or gap between bins of the at least one bin). In some cases, the trained ML model may use the one or more spatial separations as features to generate one or more layout configuration options of the one or more bins for segmenting or organizing the space within the at least one drawer.

In some embodiments, the one or more layout configuration options comprise a plurality of layout configuration options, the method further comprising: (a) generating a recommendation comprising a recommended layout configuration selected from among the plurality of layout configuration options; and (b) providing the recommended layout configuration on the GUI to the user. In some cases, the recommended layout configuration may be received by the GUI. Alternatively or additionally, the recommended layout configuration may be transmitted to the GUI. In some cases, the user may accept the recommended layout configuration. In some cases, the user may refuse the recommended layout configuration. In some cases, the user may modify the recommended layout configuration on the GUI. For example, the user may select, manipulate, or modify the recommended layout wherein the layout comprises drawer attributes, bin attributes, user criteria, or any combination thereof. In some cases, the user may modify some attributes of the recommended layout. For example, the user may modify bin attributes (e.g., relationships of bins to other bins). In some cases, the user may modify all attributes of the recommended layout. For example, the user may modify drawer attributes (e.g., spatial dimensions), bin attributes (e.g., colors, materials, or number of bins), and user criteria (e.g., preferred free space between bins). In some cases, the trained ML model may use the acceptance, refusal, or modification of the recommended layout configuration as features to generate one or more other layout configuration options of the one or more bins for segmenting or organizing the space within the at least one drawer.

### Reports

In some embodiments, the one or more layout configuration options are provided in one or more reports to the user. In some cases, the one or more reports provide one or more graphical-based layout configuration options. For example, the one or more reports may provide one or more graphical diagrams or renderings showing bins having bin attributes in the at least one drawer having drawer attributes. The one or more graphical diagrams or renderings may be provided by any method for graphically presenting layout configuration options. For example, the one or more graphical diagrams or renderings may be provided as raster-based images, vector-based images, or photo-based images. As described elsewhere herein drawer attributes may comprise spatial dimensions, structures, materials, colors, shapes, or relationships to other drawers, or any combination thereof. As described elsewhere herein, bin attributes may comprise spatial dimensions, structures, materials, colors, shapes, relationships to other bins, cost, or any combination thereof.

In some cases, the one or more reports may provide one or more textual-based layout configuration options. For example, the one or more reports may provide one or more textual descriptions of bins having bin attributes in the at least one drawer having drawer attributes. The one or more textual descriptions may be provided by any method for textually describing layout configuration options. For example, the one or more textual descriptions may be provided as printed descriptions, audio descriptions, or a combination thereof. As described elsewhere herein drawer attributes may comprise spatial dimensions, structures, materials, colors, shapes, or relationships to other drawers, or any combination thereof. As described elsewhere herein, bin attributes may comprise spatial dimensions, structures, materials, colors, shapes, relationships to other bins, cost, or any combination thereof. In some cases, the one or more reports provide one or more graphical-based layout configuration options and one or more textual-based layout configuration options.

In some embodiments, the one or more reports comprise bin purchasing data associated with the one or more bins, wherein the data comprises purchasing sources, manufacturers, suppliers, distributers, prices, user reviews, or any combination thereof.

In some cases, the one or more reports may provide one or more purchasing sources for obtaining bins recommended by the trained ML model. In some cases, the one or more purchasing sources may be available to one or more types of users having relationships with one or more other types of users. Relationships may include business to business relationships, business to consumer relationships, consumer to consumer relationships, another relationship, or any combination thereof. The one or more reports may be sorted or filtered by purchasing sources. In some cases, the trained ML model may use purchasing sources as a feature to generate one or more layout configuration options of the one or more bins for segmenting or organizing the space within the at least one drawer

In some cases, the one or more reports may provide one or more manufactures, suppliers, or distributors for obtaining bins recommended by the trained ML model. In some cases, the one or more manufactures, suppliers, or distributors may be available to one or more types of users having relationships with one or more other types of users. Relationships may include business to business relationships, business to consumer relationships, consumer to consumer relationships, another relationship, or any combination thereof. The one or more reports may be sorted or filtered by manufacturers, suppliers, or distributors. In some cases, the trained ML model may use manufacturers, suppliers, or distributors as features to generate one or more layout configuration options of the one or more bins for segmenting or organizing the space within the at least one drawer.

In some cases, the one or more reports may provide one or more prices of bins recommended by the trained ML model. For example, the one or more bins may be associated with one or more prices from one or more sources. The one or more reports may be one or more shopping lists. Prices may be compiled from any source having prices of bins. For example, prices may be compiled from marketplaces such as Amazon.com®. Prices may include one or more types of prices. Types of prices may include a manufacturer's suggested retail price (MSRP), a sales price, a membership price, a clearance price, a special price, another price, or any combination thereof. In some cases, the user may select a bin from a source having a higher price than another source because the source is preferred by the user. The user may prefer the source because the source is, for example, more accessible by the user. The one or more reports may be sorted or filtered by prices. In some cases, the trained ML model may use the one or more prices as a feature to generate one or more layout configuration options of the one or more bins for segmenting or organizing the space within the at least one drawer.

In some cases, the one or more reports may provide one or more reviews of bins recommended by the trained ML model. For example, the one or more bins may be associated with one or more reviews by one or more other users. Reviews may be compiled from any source having reviews of bins. For example, reviews may be compiled from marketplaces such as Amazon.com®. Reviews may include rating systems of bins (e.g., a review using a five-star scale where five stars is a better review than one star). Reviews may include textual reviews of bins (e.g., another user provides the user's experience with a bin). Reviews may include graphical reviews of bins (e.g., another user provides images of purchased bins in the user's drawer). In some cases, the trained ML model may use the one or more reviews as a feature to generate one or more layout configuration options of the one or more bins for segmenting or organizing the space within the at least one drawer.

In some embodiments, the one or more reports comprise bin attributes data associated with the one or more bins, wherein the data comprises spatial dimensions, structures, materials, colors, shapes, cost, or any combination thereof. As described elsewhere herein, the one or more bins may have one or more bin attributes. The one or more reports may provide data (e.g., bin attributes data) associated with the one or more bin attributes. As described elsewhere herein, the one or more reports may provide bin attributes graphically, textually, or a combination of both. In some cases, the trained ML model may use bin attributes data as a feature to generate one or more layout configuration options of the one or more bins for segmenting or organizing the space within the at least one drawer.

In some embodiments, the one or more reports comprise bin comparison data associated with the one or more bins, wherein the data compares the one or more bins between different purchasing sources, manufacturers, suppliers, distributers, or any combination thereof. As described elsewhere herein, the one or more bins may have one or more bin attributes. The one or more reports may provide data (e.g., bin comparison data) associated with the one or more bin attributes. For example, a user may obtain the same one or more bins from two or more sources of bins. The report may provide comparisons of bin attributes of the one or more bins between the two or more sources. Comparisons between the two or more sources may inform the user of the preferred source for obtaining the one or more bins. As described elsewhere herein, the one or more reports may provide bin comparison data graphically, textually, or a combination of both. In some cases, the trained ML model may use bin comparison data as a feature to generate one or more layout configuration options of the one or more bins for segmenting or organizing the space within the at least one drawer.

In some embodiments, the one or more reports comprise custom bin manufacturing data associated with the one or more bins, where the data comprises one or more manufacturers that can manufacture the one or more bins. Custom bin manufacturing data may be associated with bin attributes of the one or more recommended bins. In some cases, the one or more recommended bins may not be obtained from a source. For example, the one or more recommended bins may not be in an inventory from a source, may be discontinued by a source, may have bin attributes unavailable from a source, may be generally unavailable, or any combination thereof. The user may select a manufacturer to manufacture or generate the one or more recommended bins. The manufacturer may manufacture or generate the one or more recommended bins using custom bin manufacturing data in the one or more reports. The custom bin manufacturing data may be associated with desired bin attributes to be included in the one or more recommended bins. The custom bin manufacturing data may inform the manufacturer about manufacturing or generating the one or more recommended bins. In some cases, the trained ML model may use custom bin manufacturing data as a feature to generate one or more layout configuration options of the one or more bins for segmenting or organizing the space within the at least one drawer.

In some embodiments, the one or more reports are shared with one or more users other than the user. In some cases, the user may transmit the one or more reports. Alternatively or additionally, the one or more reports may be received by the one or more other users. Alternatively or additionally, the user may transmit the one or more reports or the one or more reports may be received by the one or more other users. In some cases, the user may share the one or more reports with one or more purchasing sources of bins. In some cases, the user may share the one or more reports with one or more sellers of bins. In some cases, the user may share the one or more reports with one or more suppliers of bins. In some cases, the user may share the one or more reports with one or more distributers of bins. In some cases, the user may share the one or more reports with one or more other users of bins.

In some cases, the user may share the one or more reports using any available method. For example, the one or more reports may be transmitted or received in the form of one or more publications. The one or more publications may include print publications, digital publications, electronic publications, or any combination thereof. In some cases, the one or more reports may be transmitted or received through one or more personal area networks, local area networks, wireless local area networks, campus area networks, metropolitan area networks, wide area networks, storage-area networks, system-area networks, enterprise private networks, virtual private networks, cellular or mobile networks, or any combination thereof.

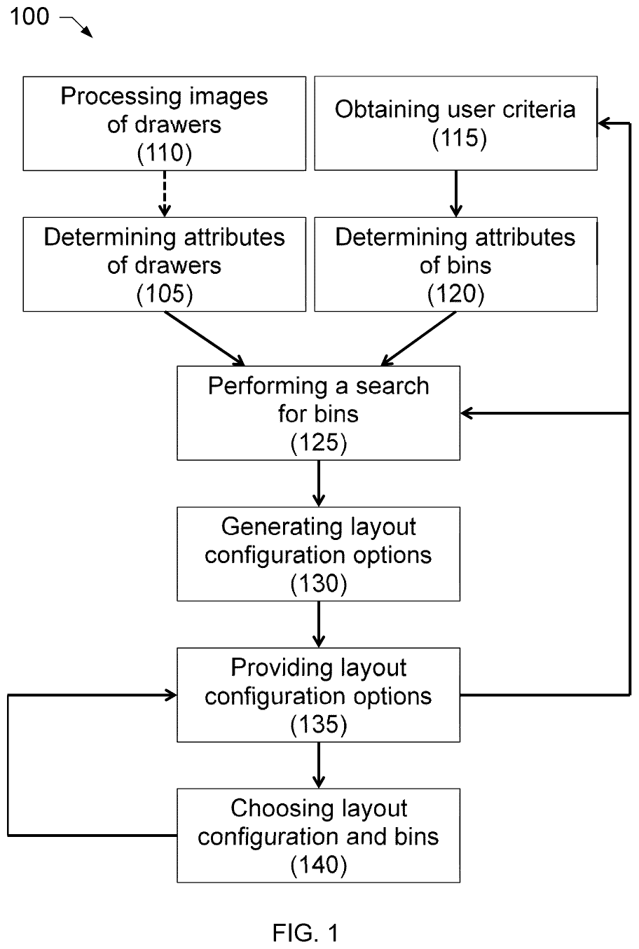

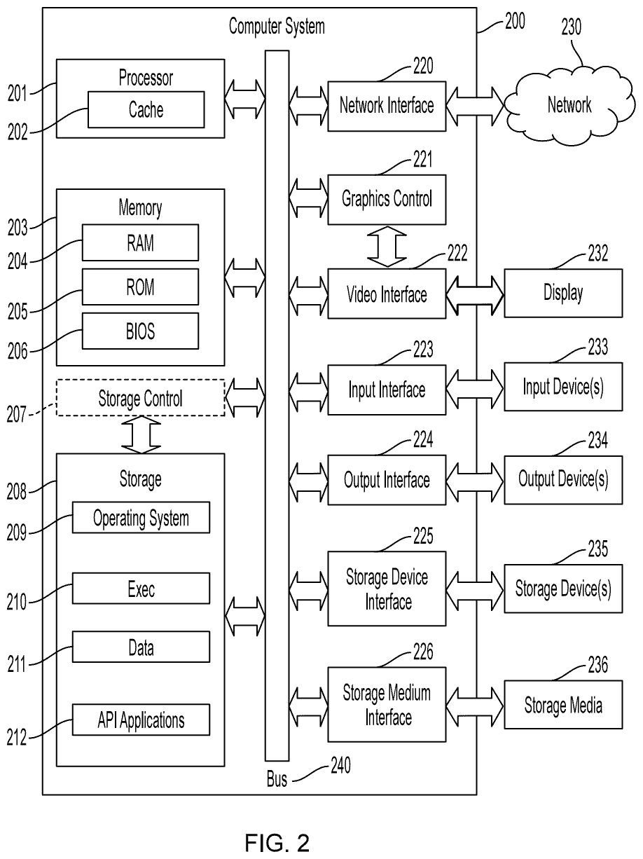

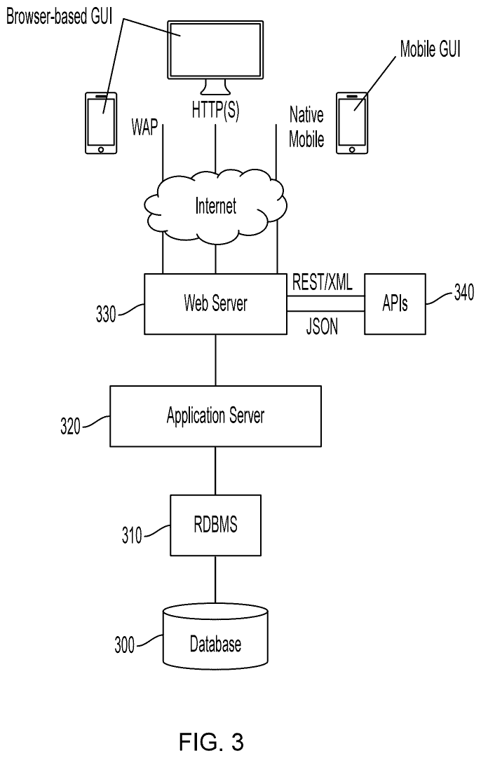

FIG. 1 depicts a flow diagram of an example procedure 100 for segmenting or organizing drawer space, according to an example embodiment of the present disclosure. The example procedure 100 includes a plurality of steps which may be carried out by the system disclosed herein for segmenting or organizing drawer space. For example, the procedure 100 may be carried out by the processor 201 described below in conjunction with FIG. 2 or the application server 320 described below in conjunction with FIG. 3. Although the procedure 100 is described with reference to the flow diagram illustrated in FIG. 1, it should be appreciated that many other methods of performing the functions associated with the procedure 100 may be used. For example, the order of many of the blocks may be changed, certain blocks may be combined with other blocks, and many of the blocks described are optional.

The example procedure 100 begins at block 105 when the system determines attributes of drawers. For example, the system may determine drawer attributes including spatial dimensions, structures, materials, colors, shapes, relationship to other drawers, drawer product data, special attributes, any other drawer attribute described above, or any combination thereof. In some examples, the drawer attributes are provided by a user. In some examples, the drawer attributes are derived from drawer product data as described above.

In some examples, the drawer attributes are determined based on images. In this case, at block 110, the system processes images of drawers. For example, a user may provide one or more images of a drawer. The example system may perform image processing on the one or more images to determine one or more drawer attributes based on the image(s).

At block 115, the system obtains user criteria for bins, drawer attributes, and/or layout preferences. For example, a user may provide preferences for one or more bin attributes. At block 120, the system determines attributes of bins. For example, the system may determine bin attributes including spatial dimensions, structures, materials, colors, shapes, cost, bin product data, any other bin attribute described above, or any combination thereof. The example system may determine bin attributes based on user input. In other examples, the system may determine bin attributes based on retrieved data.

At block 125, the system performs a search for bins. For example, the system may search a database and/or the internet for bins which are suitable for use in the one or more drawers. In some examples, the system uses the determined drawer attributes, the determined bin attributes, and/or the user criteria for bins as inputs in performing the search for the bins. For example, the system may identify bins in the database and/or via the internet which match one or more of the user criteria for bins while being suitable in spatial dimension for use in the one or more drawers. In some examples, the example search results may be stored for use in subsequent steps. In some examples, the search results may be presented to the user for further refinement.

At block 130, the system generates one or more layout configuration options. For example, the system may determine one or more options for subdividing the one or more drawers into one or more bin portions. The one or more layout configuration options may be based on the drawer attributes, the bin attributes, the user criteria, and/or the bins found at the search of block 125. At block 135, the system provides the generated layout configuration option(s) to the user.

In some examples, the user may refuse all of the provided layout configuration option(s) provided at block 135. In this case, the user may modify the recommended layout configuration on the GUI. For example, the user may select, manipulate, or modify the recommended layout wherein the layout comprises drawer attributes, bin attributes, user criteria, or any combination thereof. In some cases, the user may modify some attributes of the recommended layout. For example, the user may modify bin attributes (e.g., relationships of bins to other bins). In some cases, the user may modify all attributes of the recommended layout. For example, the user may modify drawer attributes (e.g., spatial dimensions), bin attributes (e.g., colors, materials, or number of bins), and user criteria (e.g., preferred free space between bins). After the user modifies the recommended layout configuration option(s), the process 100 returns to block 125 and the system again performs a search for bins.

In some examples, after the layout configuration options 135 are provided to the user, the process may return to block 115 to obtain additional user criteria for bins. In some examples, the process continues to block 140 and a user chooses one of the layout configuration options and proceeds to select bins for use in the layout.

In some examples, after choosing a layout configuration and bins, the user may desire to modify an aspect of the layout, drawer, or bins. In this case, the process 100 returns to block 135 to provide additional layout configuration option(s) to the user. In some examples, the user accepts the layout configuration option and bins chosen by the user at block 140 and the process ends.

### Computing System

Referring to FIG. 2, a block diagram is shown depicting an exemplary machine that includes a computer system 200 (e.g., a processing or computing system) within which a set of instructions can execute for causing a device to perform or execute any one or more of the aspects and/or methodologies for static code scheduling of the present disclosure. The components in FIG. 2 are examples only and do not limit the scope of use or functionality of any hardware, software, embedded logic component, or a combination of two or more such components implementing particular embodiments.

Computer system 200 may include one or more processors 201, a memory 203, and a storage 208 that communicate with each other, and with other components, via a bus 240. The bus 240 may also link a display 232, one or more input devices 233 (which may, for example, include a keypad, a keyboard, a mouse, a stylus, etc.), one or more output devices 234, one or more storage devices 235, and various tangible storage media 236. All of these elements may interface directly or via one or more interfaces or adaptors to the bus 240. For instance, the various tangible storage media 236 can interface with the bus 240 via storage medium interface 226. Computer system 200 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 200 includes one or more processor(s) 201 (e.g., central processing units (CPUs) or general purpose graphics processing units (GPGPUs)) that carry out functions. Processor(s) 201 optionally contains a cache memory unit 202 for temporary local storage of instructions, data, or computer addresses. Processor(s) 201 are configured to assist in execution of computer readable instructions. Computer system 200 may provide functionality for the components depicted in FIG. 2 as a result of the processor(s) 201 executing non-transitory, processor-executable instructions embodied in one or more tangible computer-readable storage media, such as memory 203, storage 208, storage devices 235, and/or storage medium 236. The computer-readable media may store software that implements particular embodiments, and processor(s) 201 may execute the software. Memory 203 may read the software from one or more other computer-readable media (such as mass storage device(s) 235, 236) or from one or more other sources through a suitable interface, such as network interface 220. The software may cause processor(s) 201 to carry out one or more processes or one or more steps of one or more processes described or illustrated herein. Carrying out such processes or steps may include defining data structures stored in memory 203 and modifying the data structures as directed by the software.

The memory 203 may include various components (e.g., machine readable media) including, but not limited to, a random access memory component (e.g., RAM 204) (e.g., static RAM (SRAM), dynamic RAM (DRAM), ferroelectric random access memory (FRAM), phase-change random access memory (PRAM), etc.), a read-only memory component (e.g., ROM 205), and any combinations thereof. ROM 205 may act to communicate data and instructions unidirectionally to processor(s) 201, and RAM 204 may act to communicate data and instructions bidirectionally with processor(s) 201. ROM 205 and RAM 204 may include any suitable tangible computer-readable media described below. In one example, a basic input/output system 206 (BIOS), including basic routines that help to transfer information between elements within computer system 200, such as during start-up, may be stored in the memory 203.

Fixed storage 208 is connected bidirectionally to processor(s) 201, optionally through storage control unit 207. Fixed storage 208 provides additional data storage capacity and may also include any suitable tangible computer-readable media described herein. Storage 208 may be used to store operating system 209, executable(s) 210, data 211, applications 212 (application programs), and the like. Storage 208 can also include an optical disk drive, a solid-state memory device (e.g., flash-based systems), or a combination of any of the above. Information in storage 208 may, in appropriate cases, be incorporated as virtual memory in memory 203.

In one example, storage device(s) 235 may be removably interfaced with computer system 200 (e.g., via an external port connector (not shown)) via a storage device interface 225. Particularly, storage device(s) 235 and an associated machine-readable medium may provide non-volatile and/or volatile storage of machine-readable instructions, data structures, program modules, and/or other data for the computer system 200. In one example, software may reside, completely or partially, within a machine-readable medium on storage device(s) 235. In another example, software may reside, completely or partially, within processor(s) 201.

Bus 240 connects a wide variety of subsystems. Herein, reference to a bus may encompass one or more digital signal lines serving a common function, where appropriate. Bus 240 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 200 may also include an input device 233. In one example, a user of computer system 200 may enter commands and/or other information into computer system 200 via input device(s) 233. Examples of an input device(s) 233 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 233 may be interfaced to bus 240 via any of a variety of input interfaces 223 (e.g., input interface 223) including, but not limited to, serial, parallel, game port, USB, FIREWIRE, THUNDERBOLT, or any combination of the above.

In particular embodiments, when computer system 200 is connected to network 230, computer system 200 may communicate with other devices, specifically mobile devices and enterprise systems, distributed computing systems, cloud storage systems, cloud computing systems, and the like, connected to network 230. Communications to and from computer system 200 may be sent through network interface 220. For example, network interface 220 may receive incoming communications (such as requests or responses from other devices) in the form of one or more packets (such as Internet Protocol (IP) packets) from network 230, and computer system 200 may store the incoming communications in memory 203 for processing. Computer system 200 may similarly store outgoing communications (such as requests or responses to other devices) in the form of one or more packets in memory 203 and communicated to network 230 from network interface 220. Processor(s) 201 may access these communication packets stored in memory 203 for processing.

Examples of the network interface 220 include, but are not limited to, a network interface card, a modem, and any combination thereof. Examples of a network 230 or network segment 230 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 230, may employ a wired and/or a wireless mode of communication. In general, any network topology may be used.

Information and data can be displayed through a display 232. Examples of a display 232 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 232 can interface to the processor(s) 201, memory 203, and fixed storage 208, as well as other devices, such as input device(s) 233, via the bus 240. The display 232 is linked to the bus 240 via a video interface 222, and transport of data between the display 232 and the bus 240 can be controlled via the graphics control 221. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 232, computer system 200 may include one or more other peripheral output devices 234 including, but not limited to, an audio speaker, a printer, a storage device, and any combinations thereof. Such peripheral output devices may be connected to the bus 240 via an output interface 224. Examples of an output interface 224 include, but are not limited to, a serial port, a parallel connection, a USB port, a FIREWIRE port, a THUNDERBOLT port, and any combinations thereof.

In addition or as an alternative, computer system 200 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, notpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®. Suitable virtual reality headset systems include, by way of non-limiting example, Meta® Oculus®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, a web application, in various embodiments, utilizes one or more software frameworks and one or more database systems. In some embodiments, a web application is created upon a software framework such as Microsoft® .NET or Ruby on Rails® (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript®, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

Referring to FIG. 3, in a particular embodiment, an application provision system comprises one or more databases 300 accessed by a relational database management system (RDBMS) 310. Suitable RDBMSs include Firebird, MySQL, PostgreSQL, SQLite, Oracle Database, Microsoft SQL Server, IBM DB2, IBM Informix, SAP Sybase, SAP Sybase, Teradata, PostGIS, time-series databases, graph databases, and the like. In this embodiment, the application provision system further comprises one or more application severs 320 (such as Java servers, .NET servers, PHP servers, and the like) and one or more web servers 330 (such as Apache, IIS, GWS and the like). The web server(s) optionally expose one or more web services via app application programming interfaces (APIs) 340. Via a network, such as the Internet, the system provides browser-based and/or mobile native user interfaces.

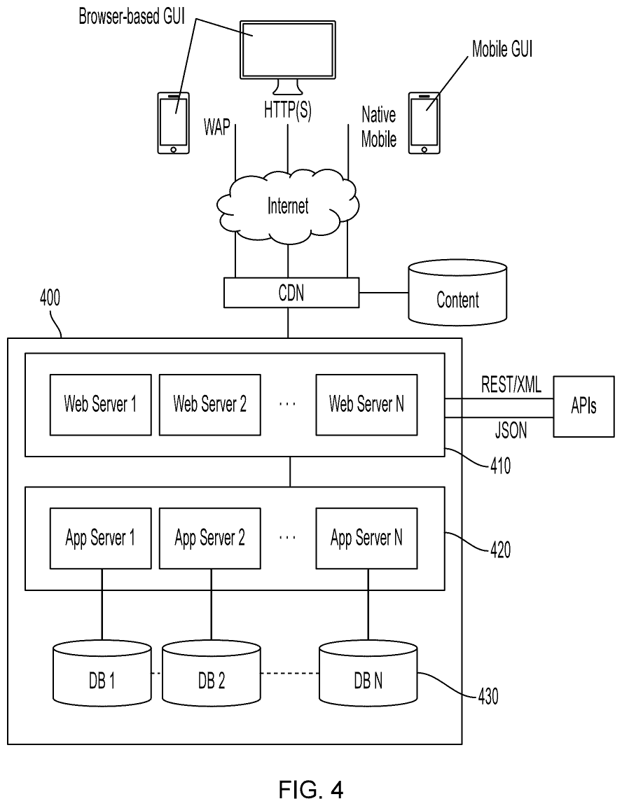

Referring to FIG. 4, in a particular embodiment, an application provision system alternatively has a distributed, cloud-based architecture 400 and comprises elastically load balanced, auto-scaling web server resources 410 and application server resources 420 as well synchronously replicated databases 430.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques using hardware, languages, and development environments. Mobile applications are written in several languages. Suitable programming languages include, by way of non-limiting examples, C, C++, C#, Objective-C, Java™, Javascript®, Pascal, Object Pascal, Python™, Ruby, VB .NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications. Additionally, microservices related to Python™ and JavaScript® may be used.

### Web Browser Plug-In

In some embodiments, the computer program includes a web browser plug-in (e.g., web extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Several web browser plug-ins may include Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Blackberry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques using machines, software, and languages. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, many databases are suitable for storage and retrieval data. In various embodiments, suitable databases include, by way of non-limiting examples, relational databases, non-relational databases, object oriented databases, object databases, entity-relationship model databases, associative databases, XML databases, time-series databases, graph databases, and the like. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### Machine Learning

Many machine learning (ML) methods implemented as algorithms are suitable as approaches to perform the methods described herein. Such methods include but are not limited to supervised learning approaches, unsupervised learning approaches, semi-supervised approaches, or any combination thereof.

Machine learning algorithms may include without limitation neural networks (e.g., artificial neural networks (ANN), multi-layer perceptrons (MLP)), support vector machines, k-nearest neighbors, Gaussian mixture model, Gaussian, naive Bayes, decision trees, or radial basis functions (RBF). Linear machine learning algorithms may include without limitation linear regression, logistic regression, naive Bayes classifier, perceptron, or support vector machines (SVMs). Other machine learning algorithms for use with methods according to the disclosure may include without limitation quadratic classifiers, k-nearest neighbor, boosting, decision trees, random forests, neural networks, pattern recognition, Bayesian networks, or Hidden Markov models. Other machine learning algorithms, including improvements or combinations of any of these, commonly used for machine learning, can also be suitable for use with the methods described herein. Any use of a machine learning algorithm in a workflow can also be suitable for use with the methods described herein. The workflow can include, for example, cross-validation, nested-cross-validation, feature selection, row compression, data transformation, binning, normalization, standardization, and algorithm selection.

A machine learning algorithm can generally be trained by the following methodology:
1. Gather a dataset for “training” and “testing” the machine learning algorithm. The dataset can include many features, for example, drawer attributes, bin attributes, or user criteria. The training dataset is used to “train” the machine learning algorithm. The testing dataset is used to “test” the machine learning algorithm.
2. Determine “features” for the machine learning algorithm to use for training and testing. The accuracy of the machine learning algorithm may depend on how the features are represented. For example, feature values may be transformed using one-hot encoding, binning, standardization, or normalization. Also, not all features in the dataset may be used to train and test the machine learning algorithm. Selection of features may depend on, for example, available computing resources and time or importance of features discovered during iterative testing and training. For example, it may be discovered that features associated with drawer attributes (e.g., moisture resistant drawers), bin attributes (e.g., BP-free bins), and user criteria (e.g., bins having open front sides) are predictive for generating an optimal layout configuration option for segmenting or organizing space within drawers.
3. Choose an appropriate machine learning algorithm. For example, a machine learning algorithm described elsewhere herein may be chosen. The chosen machine learning algorithm may depend on, for example, available computing resources and time or whether the prediction is continuous or categorical in nature. The machine learning algorithm is used to build the machine learning model.
4. Build the machine learning model. The machine learning algorithm is run on the gathered training dataset. Parameters of the machine learning algorithm may be adjusted by optimizing performance on the testing dataset or via cross-validation datasets. After parameter adjustment and learning, the performance of the machine learning algorithm may be validated on a dataset of naive samples that are separate from the training dataset and testing dataset. The built machine learning model can involve feature coefficients, importance measures, or weightings assigned to individual features.

Once the machine learning model is determined as described above (“trained”), it can be used to make a prediction for an optimal layout configuration option for segmenting or organizing space within drawers.

### User Interface Examples

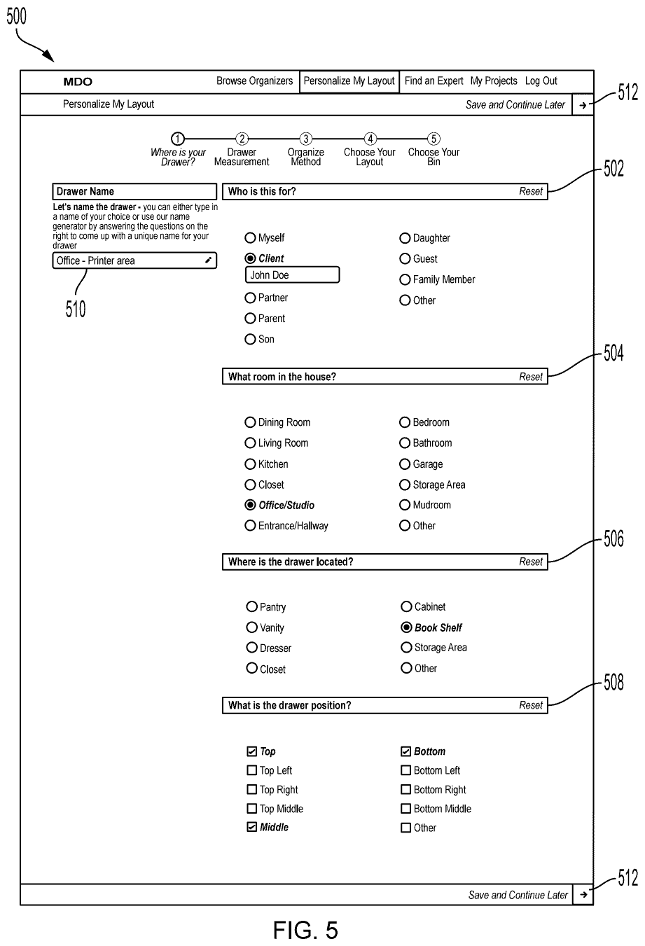

FIG. 5 is a diagram of an example user input user interface 500, according to an example embodiment of the present disclosure. The example user input user interface 500 may be used by a user of the computer system 200 to provide information corresponding to a drawer for which the user desires a layout. The example of FIG. 5 illustrates use of a web browser by the computer system 200 to access the user input user interface 500. However, it should be appreciated that the user input user interface 500 may be provided in an application that is executed on the computer system 200 to interface with the web server 330 and/or the application server 320.

The example user input user interface 500 of FIG. 5 includes a plurality of fields for a user to enter drawer identifying information. For example, the drawer identifying information may be used by the user and/or the system to identify a particular drawer for generating a layout.

The first example field of the user input user interface 500 is the drawer user field 502. The example drawer user field 502 may be used to specify a user of the drawer. The example user of the drawer may be selected from a list of user types (e.g., self, client, partner, son, daughter, etc.) or from a list of names of previously entered users. In some examples, the user may select a user type and enter in a name of the drawer user.

The second example field of the user input user interface 500 is the room field 504. The example room field 504 may be used to specify a room (e.g., a room within a house, a room within an office, etc.) where the drawer is located. The third example field of the user input user interface 500 is the drawer location field 506. The example drawer location field 506 may be used to specify a location of the drawer within the room. For example, the drawer location may correspond to a piece of furniture, a specific portion of the room, or any identifying information which specifies the location of the drawer within the room. The fourth example field of the user input user interface 500 is the drawer position field 508. The example drawer position field 508 may be used to specify a position of the drawer within the drawer's location. For example, a user may select one or more position descriptors (e.g., top, middle, bottom, right, left, top right, top left, etc.) to specify the position of the drawer within the location.

In some examples, the example user input user interface 500 may include additional fields for drawer identifying information other than the drawer user field 502, the room field 504, the drawer location field 506, and the drawer position field 508. In some examples, one or more of the drawer user field 502, the room field 504, the drawer location field 506, or the drawer position field 508 may be omitted from the example user input user interface 500. A user may enter drawer identifying information each of the fields of the user input user interface 500, a portion of the fields of the user input user interface 500, or none of the fields of the user input user interface 500.

The example user input user interface 500 includes a drawer name dialog 510. The example drawer name dialog 510 may be used to generate a name corresponding to the drawer for which information is gathered in the user input user interface 500. In some examples, the user may enter a name into the drawer name dialog 510. In other examples, the system may generate a name for the drawer based on the drawer identifying information entered in one or more fields of the drawer identification page. After a user has completed entering in desired drawer identifying information into the user input user interface 500, the user may use the navigation button 512 to proceed to a subsequent step of the system.

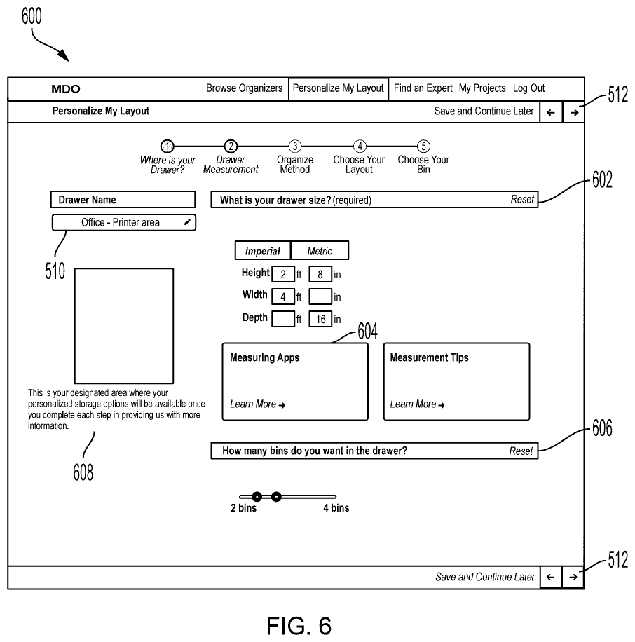

FIG. 6 is a diagram of an example drawer attribute user interface 600, according to an example embodiment of the present disclosure. The example drawer attribute user interface 600 may be used by a user of the computer system 200 to provide drawer attributes and/or user criteria corresponding to a drawer for which the user desires a layout. The example of FIG. 6 illustrates use of a web browser by the computer system 200 to access the drawer attribute user interface 600. However, it should be appreciated that the drawer attribute user interface 600 may be provided in an application that is executed on the computer system 200 to interface with the web server 330 and/or the application server 320.

The example drawer attribute user interface 600 includes one or more fields corresponding to drawer attributes. For example, the example drawer attribute user interface 600 includes a drawer size field 602. The example drawer size field 602 may be used to obtain spatial dimensions of the drawer for which the user desires a layout. In some examples, a user may provide the spatial dimensions of the drawer. As such, the example drawer size field 602 of FIG. 6 includes dimension fields where a user may enter in one or more of the height, width, or depth of the drawer. The example drawer size field 602 allows the user to select desired units (e.g., imperial, metric) for the dimension fields.

In other examples, the user may access a measuring application 604. The example measuring application 604 may determine spatial dimensions of the drawer based on image processing. For example, the user may provide one or more images of the drawer. The example measuring application 604 may then use image processing to determine spatial dimensions of the drawer and populate the dimension fields of the drawer size field 602 using the determined spatial dimensions.

The example drawer attribute user interface 600 includes one or more fields corresponding to user criteria for the drawer. For example, the drawer attribute user interface 600 includes a bin quantity field 606. The example bin quantity field 606 allows a user to specify one or more of a maximum number of bins and/or a minimum number of bins that the user desires for the drawer. In some examples, the maximum number of bins and the minimum number of bins is the same such that the user specifies a specific number of desired bins. In other examples, the maximum number of bins is greater than the minimum number of bins such that the user specifies an allowable range for the desired quantity of bins.

The example drawer attribute user interface 600 includes a drawer representation 608. The example drawer representation 608 includes a two-dimensional representation of the drawer. For example, the drawer representation 608 may include a scaled rectangle of a top view (e.g., width and depth) of the drawer. The example drawer attribute user interface 600 includes the drawer name dialog 510 and the navigation buttons 512.

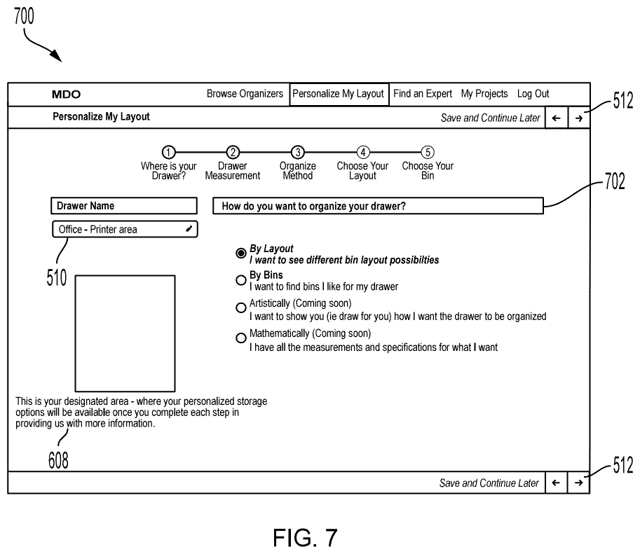

FIG. 7 is a diagram of an example organization method selection user interface 700, according to an example embodiment of the present disclosure. The example organization method selection user interface 700 may be used by a user of the computer system 200 to select an organization method for generating a layout of a drawer. The example of FIG. 7 illustrates use of a web browser by the computer system 200 to access the organization method selection user interface 700. However, it should be appreciated that the organization method selection user interface 700 may be provided in an application that is executed on the computer system 200 to interface with the web server 330 and/or the application server 320.

The example organization method selection user interface 700 includes an organization method selection field 702. The example organization method selection field 702 includes a list of organization method types (e.g., by layout, by bins, artistically, mathematically, etc.). A user may select one of the organization method types for the system to use in generating a layout for the drawer. The example organization method selection user interface 700 further includes the drawer representation 608, the drawer name dialog 510 and the navigation buttons 512.

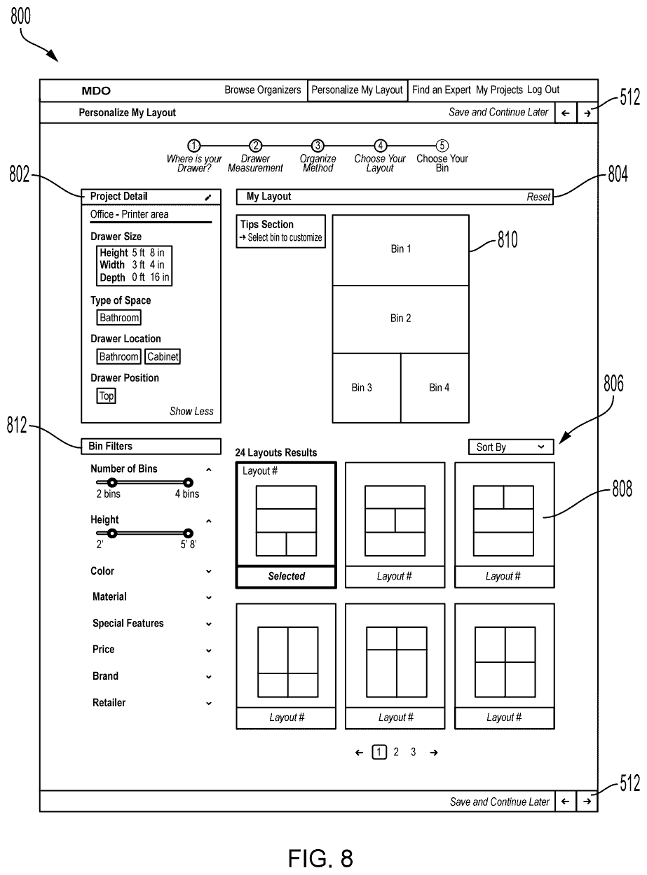

FIG. 8 is a diagram of an example layout selection user interface 800, according to an example embodiment of the present disclosure. The example layout selection user interface 800 may be used to display drawer layout options and for selection of a drawer layout by a user of the computer system 200. The example of FIG. 8 illustrates use of a web browser by the computer system 200 to access the layout selection user interface 800. However, it should be appreciated that the layout selection user interface 800 may be provided in an application that is executed on the computer system 200 to interface with the web server 330 and/or the application server 320.

The example layout selection user interface 800 includes a project detail section 802. The example project detail section 802 displays information corresponding to the drawer for which layouts have been generated. For example, the project detail section 802 displays one or more of drawer attributes, drawer location information, and the drawer name.

The example layout selection user interface 800 includes a layout section 804. The example layout section includes a layout results section 806 and a selected layout 810. The example layout results section 806 displays one or more generated layouts 808 which have been generated by the system for the drawer described in the project detail section 802. Each generated layout 808 includes a graphical representation of the layout. The graphical representation of the generated layout 808 may include a drawer representation (e.g., the drawer representation 608 of FIG. 6) that has been subdivided into one or more segments corresponding to a bin.

A user may select one of the generated layouts 808 to be displayed as the selected layout 810. The example selected layout 810 includes a graphical representation of the layout and further includes bin identifiers for each one of the one or more segments of the layout. For example, the selected layout 810 of FIG. 8 includes four segments. Each of the four segments is labeled corresponding to a bin identification number (e.g., Bin 1, Bin 2, Bin 3, and Bin 4). In some examples, the segments displayed in the selected layout 810 may be selectable by a user in order to select a bin for the segment. For example, a user may select (e.g., click, tap, etc.) a segment to access a bin selection page (e.g., the first example bin selection user interface 900 or the bin search user interface 1100 described below).

The example layout selection user interface 800 includes a bin filters section 812. The example bin filters section 812 displays bin attributes considered by the system when generating the layouts displayed in the layout section 804. In some examples, a user may modify one or more of the bin attributes displayed in the bin filters section 812. In response to modification of one or more of the bin attributes, the system may generate drawer layouts based on the modified bin attributes.

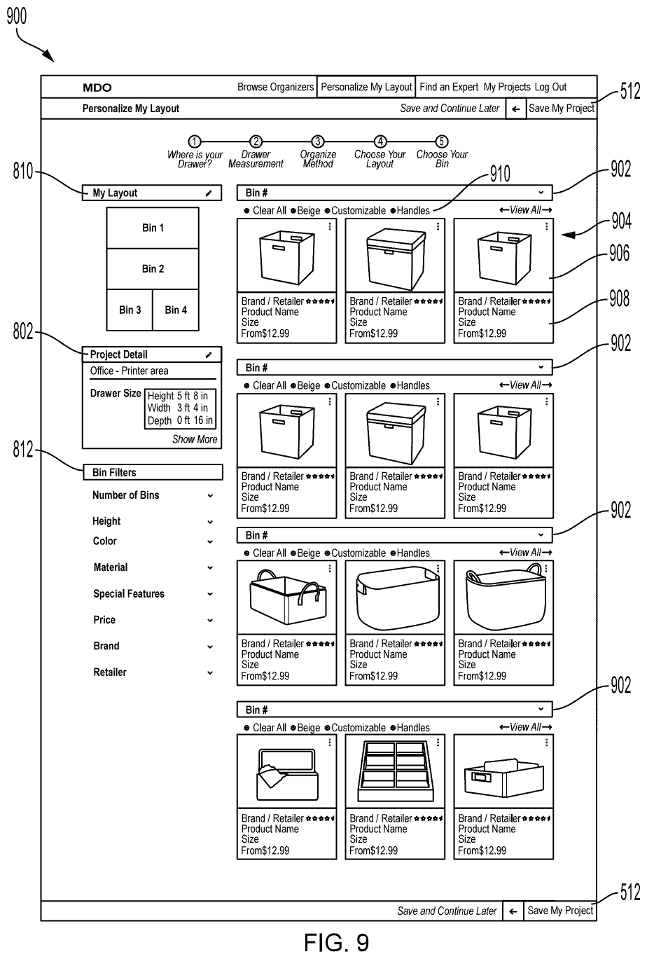

FIG. 9 is a diagram of a first example bin selection user interface 900, according to an example embodiment of the present disclosure. The first example bin selection user interface 900 may be used to display bin options and for selection of one or more bins by a user of the computer system 200. The example of FIG. 9 illustrates use of a web browser by the computer system 200 to access the first example bin selection user interface 900. However, it should be appreciated that the first example bin selection user interface 900 may be provided in an application that is executed on the computer system 200 to interface with the web server 330 and/or the application server 320.

The first example bin selection user interface 900 displays the selected layout 810, the project detail section 802, and the bin filters section 812. The first example bin selection user interface 900 further includes one or more bin selection sections 902. The first example bin selection user interface 900 may include a number of bin selection sections 902 corresponding to the number of bins in the selected layout 810. Each of the example bin selection sections 902 includes one or more bin options 904. Each of the example bin options 904 includes a bin image 906 and a bin details section 908. The example bin details section 908 may include one or more details corresponding to the bin option 904 including, but not limited to, a retailer of the bin, the product name of the bin, the size of the bin, the price of the bin, and a rating of the bin.

Each of the example bin selection sections 902 may include active bin filters 910. The example active bin filters 910 may display one or more bin filters (e.g., corresponding to one or more bin attributes) which have been considered by the system for the bin selection section 902. The user may select one or more of the displayed bin filters of the active bin filters 910 to remove the selected bin filter for the example bin selection section 902. In this case, the system may update the bin options 904 displayed in the bin selection section 902 based on the new active bin filters 910.

An example user may browse the one or more bin options 904 in each of the example bin selection sections 902 and select one or more favorite bins for each bin of the selected layout 810. The system may store the favorite bin option 904. In some examples, a user may select two or more favorite bin options 904 for a bin of the selected layout 810. In other examples, a user may not accept any of the bin options 904 in a bin selection section 902. In this case, the system may select a bin option 904 based on the selected layout 810 and the bin filters.

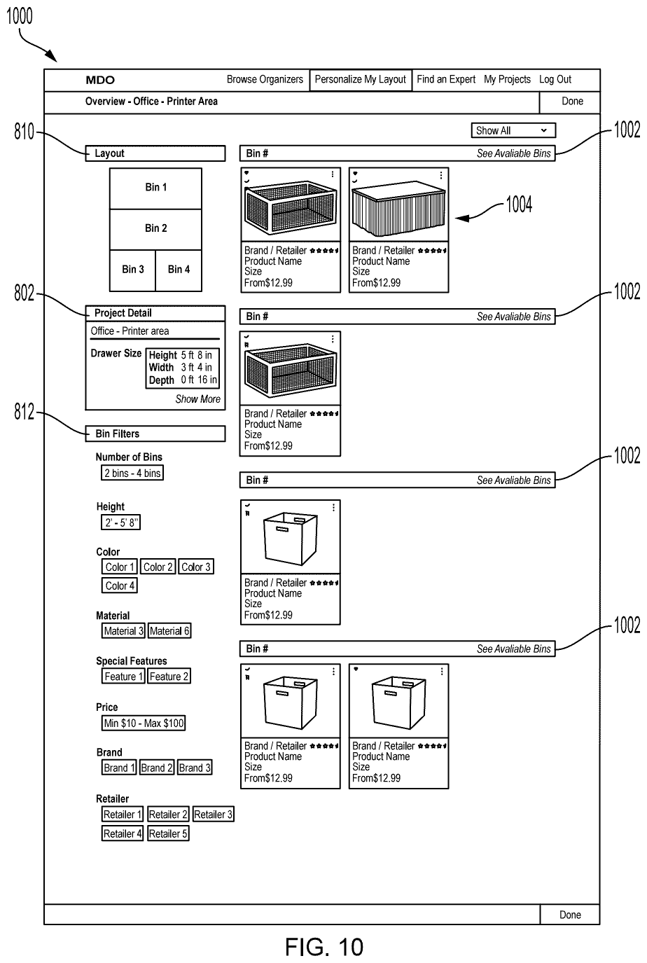

FIG. 10 is a diagram of an example report user interface 1000, according to an example embodiment of the present disclosure. The example report user interface 1000 may be used to display selected drawer layout and one or more selected bins for a drawer. The example of FIG. 10 illustrates use of a web browser by the computer system 200 to access the report user interface 1000. However, it should be appreciated that the report user interface 1000 may be provided in an application that is executed on the computer system 200 to interface with the web server 330 and/or the application server 320.

The example report user interface 1000 displays the selected layout 810, the project detail section 802, and the bin filters section 812. The example report user interface 1000 further includes one or more bin sections 1002. The example report user interface 1000 may include a number of bin sections 1002 corresponding to the number of bins in the selected layout 810. Each of the example bin sections 1002 includes one or more selected bins 1004. The example selected bins 1004 may correspond to the favorite bins selected by the user on the first example bin selection user interface 900, favorite bins selected by the user on the bin search user interface 1100, or bins selected by the system.

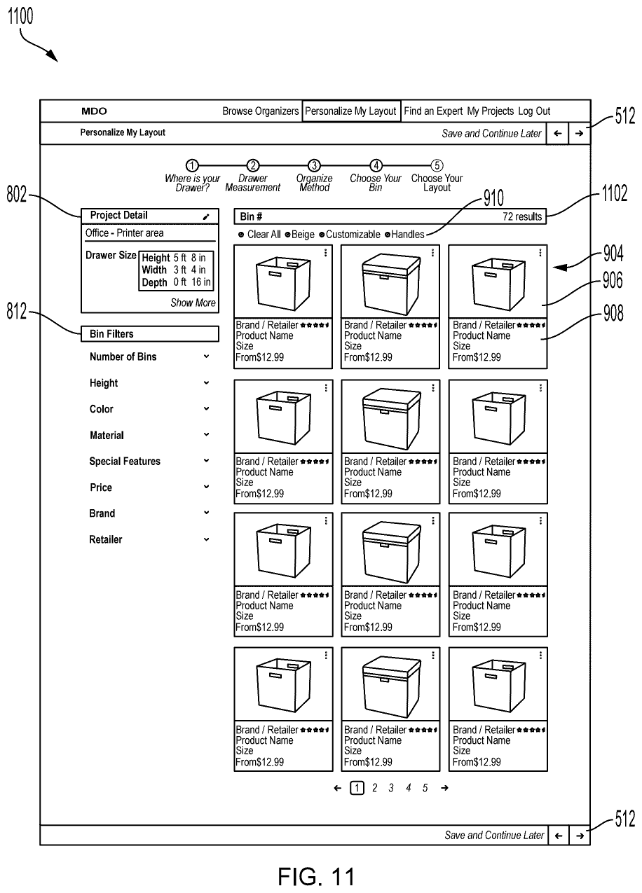

FIG. 11 is a diagram of a bin search user interface 1100, according to an example embodiment of the present disclosure. The bin search user interface 1100 may be used to display bin options and for selection of one or more bins by a user of the computer system 200. The example of FIG. 11 illustrates use of a web browser by the computer system 200 to access the bin search user interface 1100. However, it should be appreciated that the bin search user interface 1100 may be provided in an application that is executed on the computer system 200 to interface with the web server 330 and/or the application server 320.

The bin search user interface 1100 may be used prior to generation of or selection of a drawer layout. As such, the bin search user interface 1100 displays the project detail section 802 and the bin filters section 812, but does not include a selected layout. The bin search user interface 1100 includes a bin selection section 1102 which displays one or more bin options 904 including a bin image 906 and a bin details section 908. The example bin selection section 1102 also includes the active bin filters 910.

An example user may browse the one or more bin options 904 and select one or more favorite bins. The system may store the one or more favorite bins and use the one or more favorite bins as input for generating drawer layouts. For example, the system may generate a layout that incorporates bin section dimensions corresponding to one or more of the favorite bins. In some examples, a generated layout may include only a user's favorite bins. In some examples, a generated layout may include one or more of a user's preferred bins.

### Process Examples

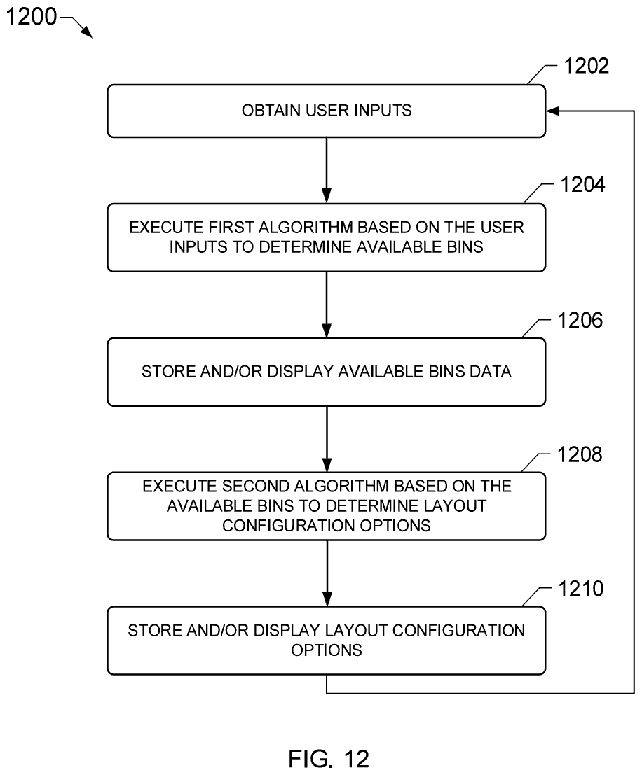

FIG. 12 depicts a flow diagram for a second procedure 1200 for segmenting or organizing drawer space, in accordance with some embodiments disclosed herein. The example second procedure 1200 includes a plurality of steps which may be carried out by the system disclosed herein for segmenting or organizing drawer space. For example, the second procedure 1200 may be carried out by the processor 201 described in conjunction with FIG. 2 or the application server 320 described in conjunction with FIG. 3. Although the second procedure 1200 is described with reference to the flow diagram illustrated in FIG. 12, it should be appreciated that many other methods of performing the functions associated with the second procedure 1200 may be used. For example, the order of many of the blocks may be changed, certain blocks may be combined with other blocks, and many of the blocks described are optional.

The example second procedure 1200 begins at block 1202 where the system obtains user inputs. For example, the system may obtain user criteria for bins, drawer attributes, and/or layout preferences. At block 1204, the system executes a first algorithm based on the user inputs to determine available bins. For example, the available bins may match one or more of the user criteria for bins, drawer attributes, and/or layout preferences obtained from the user at block 1202. At block 1206, the system stores and/or displays the available bins data. In some examples, the available bins data is only stored and not displayed to the user. In other examples, the available bins data is stored and displayed to the user. At block 1208, the system executes a second algorithm based on the available bins to determine layout configurations using example methods disclosed herein. At block 1210, the system stores and/or displays the layout configuration options. In some examples, the layout configuration options are only stored and not displayed to the user. In other examples, the layout configuration options are both stored and displayed to the user. After execution of block 1210, the example second procedure 1200 may end. In other examples, after execution of block 1210, the example second procedure 1200 may return to block 1202 to obtain additional user inputs.

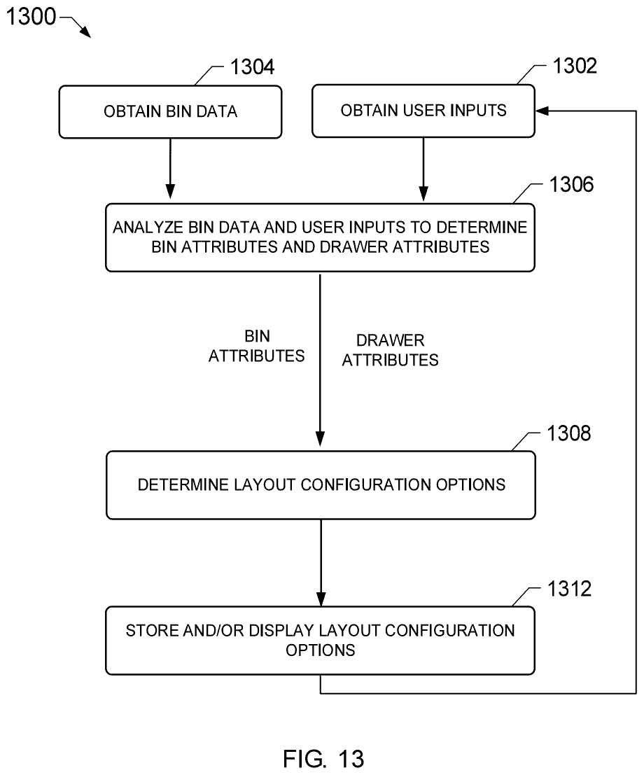

FIG. 13 depicts a flow diagram for a third procedure 1300 for segmenting or organizing drawer space, in accordance with some embodiments disclosed herein. The example third procedure 1300 includes a plurality of steps which may be carried out by the system disclosed herein for segmenting or organizing drawer space. For example, the third procedure 1300 may be carried out by the processor 201 described in conjunction with FIG. 2 or the application server 320 described in conjunction with FIG. 3. Although the third procedure 1300 is described with reference to the flow diagram illustrated in FIG. 13, it should be appreciated that many other methods of performing the functions associated with the third procedure 1300 may be used. For example, the order of many of the blocks may be changed, certain blocks may be combined with other blocks, and many of the blocks described are optional.

The example third procedure 1300 begins at block 1302 where the system obtains user inputs. For example, the system may obtain user criteria for bins, drawer attributes, and/or layout preferences. At block 1304, the system obtains bin data. For example, the system may search one or more of a database or the internet to locate bins. The example system may then extract bin data from the search. At block 1306, the system analyzes the bin data and the user inputs to determine bin attributes and drawer attributes. For example, the system may assign drawer attributes to the drawer based on the user inputs. In some examples, the system may assign bin attributes to one or more bins based on the bin data. In some examples, the system executes one or more algorithms to merge bin attributes obtained from two or more sources of bin attributes. In some examples, the system may determine desired bin attributes based on the drawer attributes and/or the user inputs.

At block 1308, the system determines layout configuration options based on the bin attributes and the drawer attributes. For example, the system may identify suitable bins based on the bin attributes and the drawer attributes and determine layouts of the suitable bins for use within the drawer. At block 1312, the system stores and/or displays the layout configuration options. In some examples, the layout configuration options are only stored and not displayed to the user. In other examples, the layout configuration options are both stored and displayed to the user. The example system may render graphical representations of the layout configuration options for display to the user at block 1312. After execution of block 1312, the example third procedure 1300 may end. In other examples, after execution of block 1312, the example third procedure 1300 may return to block 1302 to obtain additional user inputs.

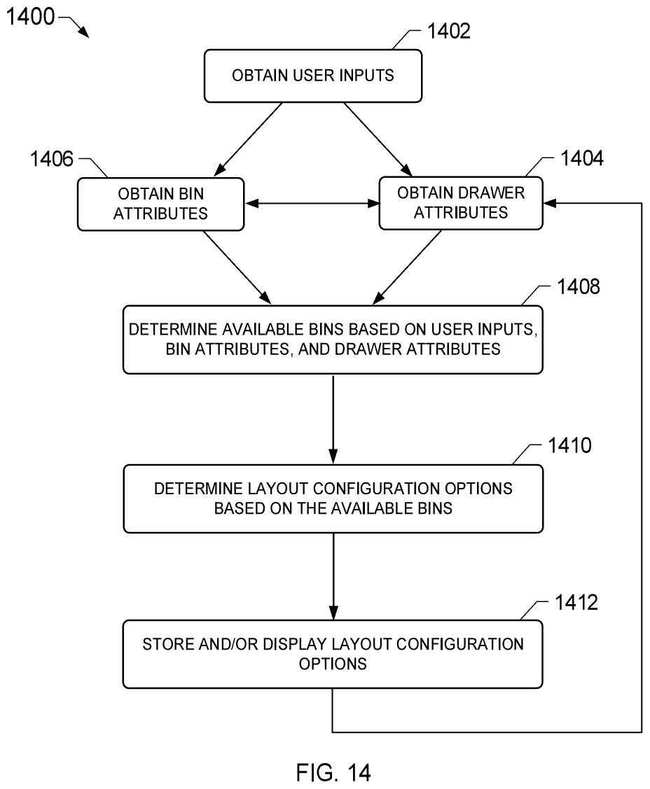

FIG. 14 depicts a flow diagram for a fourth procedure 1400 for segmenting or organizing drawer space, in accordance with some embodiments disclosed herein. The example fourth procedure 1400 includes a plurality of steps which may be carried out by the system disclosed herein for segmenting or organizing drawer space. For example, the fourth procedure 1400 may be carried out by the processor 201 described in conjunction with FIG. 2 or the application server 320 described in conjunction with FIG. 3. Although the fourth procedure 1400 is described with reference to the flow diagram illustrated in FIG. 14, it should be appreciated that many other methods of performing the functions associated with the fourth procedure 1400 may be used. For example, the order of many of the blocks may be changed, certain blocks may be combined with other blocks, and many of the blocks described are optional.

The example fourth procedure 1400 begins at block 1402 where the system obtains user inputs. For example, the system may obtain user criteria for bins, drawer attributes, and/or layout preferences. At block 1404, the system obtains drawer attributes. For example, drawer attributes may be obtained from user inputs, obtained from drawer product data, or derived from bin attributes. At block 1406, the system obtains bin attributes. For example, bin attributes may be obtained from user inputs, obtained bin product data, derived from merged bin product data, or derived from drawer attributes. At block 1408, the system determines available bins based on one or more of the user inputs, the bin attributes (e.g., the assigned bin attributes and/or the desired bin attributes) and the drawer attributes. For example, the system may identify bins which have assigned bin attributes that satisfy one or more of the user inputs, the drawer attributes, and the desired bin attributes.

At block 1410, the system determines layout configuration options based on the available bins. For example, the system may determine configurations of one or more available bins such that the bins occupy the spatial dimensions of the drawer. At block 1412, the system stores and/or displays the layout configuration options. In some examples, the layout configuration options are only stored and not displayed to the user. In other examples, the layout configuration options are both stored and displayed to the user. The example system may render graphical representations of the layout configuration options for display to the user at block 1412. After execution of block 1412, the example fourth procedure 1400 may end. In other examples, after execution of block 1412, the example fourth procedure 1400 may return to block 1402 to obtain additional user inputs.

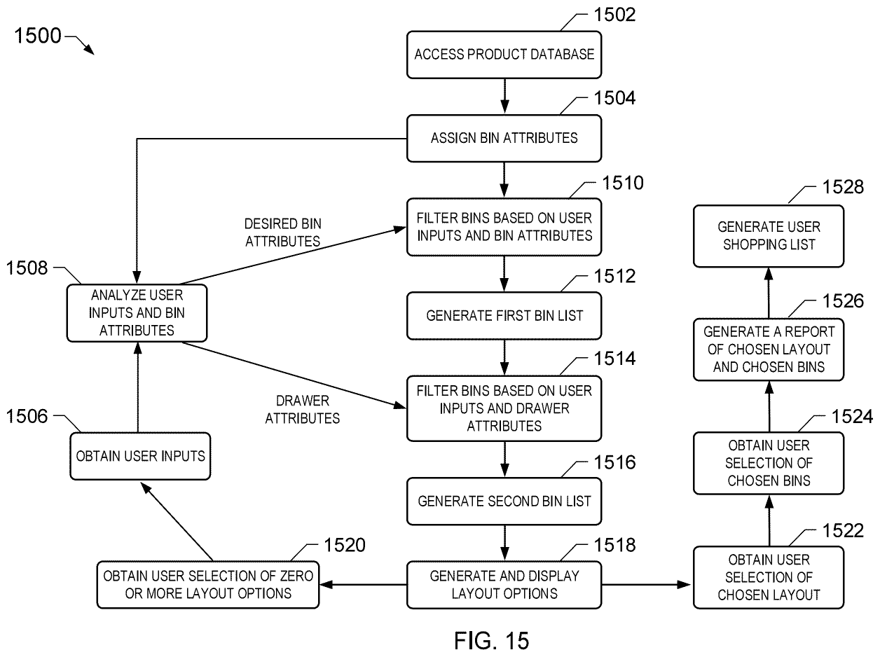

FIG. 15 depicts a flow diagram for a fifth procedure 1500 for segmenting or organizing drawer space, in accordance with some embodiments disclosed herein. The example fifth procedure 1500 includes a plurality of steps which may be carried out by the system disclosed herein for segmenting or organizing drawer space. For example, the fifth procedure 1500 may be carried out by the processor 201 described in conjunction with FIG. 2 or the application server 320 described in conjunction with FIG. 3. Although the fifth procedure 1500 is described with reference to the flow diagram illustrated in FIG. 15, it should be appreciated that many other methods of performing the functions associated with the fifth procedure 1500 may be used. For example, the order of many of the blocks may be changed, certain blocks may be combined with other blocks, and many of the blocks described are optional.

The example fifth procedure 1500 begins at block 1502 where the system accesses a product database. The example product database includes bin data (e.g., bin product data) from one or more retailers. At block 1504, the system assigns bin attributes based on the bin data in the product database. In some examples, the assigned bin attributes are obtained directly from the product database. In some examples, the system may merge similar descriptions from different retailers when assigning bin attributes. In some examples, the system may infer bin attributes based on bin data from the product database.

At block 1506, the system obtains user inputs. For example, the system may obtain user criteria for bins, drawer attributes, and/or layout preferences. At block 1508, the system analyzes the assigned bin attributes and the user inputs to determine desired bin attributes and drawer attributes. For example, the system may assign drawer attributes to the drawer based on the user inputs. In some examples, the system may assign bin attributes to one or more bins based on the bin data. In some examples, the system executes one or more algorithms to merge bin attributes obtained from two or more sources of bin attributes. In some examples, the system may determine desired bin attributes based on the drawer attributes and/or the user inputs.

At block 1510, the system determines available bins based on one or more of the user inputs and the bin attributes (e.g., the assigned bin attributes and/or the desired bin attributes). For example, the system may identify bins in the product database which have assigned bin attributes that satisfy one or more of the user inputs and the desired bin attributes. At block 1512, the system generates a first bin list based on the available bins identified at block 1510. At block 1514, the system further filters the first bin list based on the drawer attributes and user inputs. For example, the system may identify bins in the first bin list which have assigned bin attributes that satisfy one or more of the drawer attributes and user inputs. At block 1516, the system generates a second bin list based on the bins identified at block 1514.

At block 1518, generates and displays layout configuration options. For example, the system may generate layout configuration options by determining configurations of one or more bins from the second bin list such that the bins occupy the spatial dimensions of the drawer. The example system may then render graphical representations of the layout configuration options and display the layout configuration options to the user at block 1518. In some examples, the user may not be satisfied with any of the layout configuration options presented at block 1518. In these examples, at block 1520, the user may select none of the layout configuration options and request additional layout configuration options to be generated and displayed. In some examples, at block 1520 the user may select one or more layouts with which the user is partially satisfied. In these examples, the user may select the portion of the layout with which they are satisfied, the selection of which may act as additional user input at block 1506.

In other examples, the user may be satisfied with one of the layout configuration options presented at block 1518 and the user may select the layout as a chosen layout. At block 1522, the system obtains the user's selection of a chosen layout. At block 1524, the system obtains user selection of bins for the chosen layout. For example, the system may display options for bins matching the bin attributes for the chosen layout which are available to purchase at a retailer. The system may obtain a user selection for each bin included in the chosen layout. At block 1526, the system generates a report of the layout chosen at block 1522 and the bins chosen at block 1524. At block 1528, the system generates a shopping list of the chosen bins. For example, the system may generate a sortable shopping list of the bins chosen at block 1524. The user may sort the shopping list by drawer, room, retailer, etc. The shopping list may also include a graphical representation of the chosen bins within the chosen layout for the drawer.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### EXAMPLES

The following illustrative examples are representative of embodiments of the platform, software applications, systems, or methods described herein and are not meant to be limiting in any way.

### Example 1

A first example uses a layout selection organization method. The first example includes the steps of: (i) obtaining drawer attributes including measurements from a user; (ii) selecting an organization method; (iii) obtaining desired bin attributes from a user; (iv) choosing a layout configuration; and (v) choosing bins.

For example, to execute step (i), a user may access the example user input user interface 500 of FIG. 5 and provide drawer identifying information. The user may then access the example drawer attribute user interface 600 of FIG. 6 and provide spatial dimensions of the drawer in the drawer size field 602. At step (ii), the user may access the example organization method selection user interface 700 of FIG. 7. In the first example, the user selects the method “By Layout” in the organization method selection field 702. After the user selects the layout organization method, the system may generate layout options.

At step (iii), the user may access the example layout selection user interface 800 of FIG. 8 to view the generated layout options. The user may further modify the bin attributes in the bin filters section 812 to match their desired bin attributes. At step (iv), the user may browse the generated layouts 808 and choose a selected layout 810. At step (v), the user may access the first example bin selection user interface 900 of FIG. 9 to choose bins. For example, the user may choose one or more bins for each bin portion of the selected layout. Subsequent to the steps (i)-(v), the user may access the example report user interface 1000 of FIG. 10 to view the selected drawer layout, the selected bins, the project details, and the bin filters used when selecting the bins.

### Example 2

A second example uses a bin selection organization method. The second example includes the steps of: (i) obtaining drawer attributes including measurements from a user; (ii) selecting an organization method; (iii) obtaining desired bin attributes from a user; (iv) choosing bins favorites; and (v) choosing a layout configuration.

For example, to execute step (i), a user may access the example user input user interface 500 of FIG. 5 and provide drawer identifying information. The user may then access the example drawer attribute user interface 600 of FIG. 6 and provide spatial dimensions of the drawer in the drawer size field 602. At step (ii), the user may access the example organization method selection user interface 700 of FIG. 7. In the second example, the user selects the method “By Bins” in the organization method selection field 702.

After the user selects the bin selection organization method, the system may display the bin search user interface 1100. At step (iii), the user may use the bin filters section 812 to provide one or more desired bin attributes to the system. The system may display one or more bin options 904 based on the provided bin attributes. At step (iv), the user may select one or more favorite bins of the one or more bin options 904 displayed in the bin selection section 1102. The system may then generate layout options using one or more of the favorite bins and display the example layout selection user interface 800 of FIG. 8.

At step (v), the user may browse the generated layouts 808 and choose a selected layout 810. Subsequent to the steps (i)-(v), the user may access the example report user interface 1000 of FIG. 10 to view the selected drawer layout, the selected bins, the project details, and the bin filters used when selecting the bins.

### Example 3

A third example uses an artistic organization method. The third example includes the steps of: (i) obtaining drawer attributes including measurements from a user; (ii) selecting an organization method; (iii) obtaining a layout sketch (iv) obtaining desired bin attributes from a user; (iv) choosing a layout configuration; and (v) choosing bins.

For example, to execute step (i), a user may access the example user input user interface 500 of FIG. 5 and provide drawer identifying information. The user may then access the example drawer attribute user interface 600 of FIG. 6 and provide spatial dimensions of the drawer in the drawer size field 602. At step (ii), the user may access the example organization method selection user interface 700 of FIG. 7. In the third example, the user selects the method “Artistically” in the organization method selection field 702.

At step (iii), after the user selects the artistic organization method, the system obtains a layout sketch from the user. For example, the user may upload a photo or drawing of a desired drawer layout. In another example, the system may provide an interface for the user to sketch a desired drawer layout. At step (iv), the system obtains desired bin attributes from the user. For example, the system may display the bin search user interface 1100. The user may use the bin filters section 812 to provide one or more desired bin attributes to the system.

After drawer attributes, bin attributes, and the sketch are obtained, the system may generate layout options based on the obtained data. For example, the system may generate layouts that appear similar to the sketch while using bin dimensions from real bin data. Subsequently, the user may access the example layout selection user interface 800 of FIG. 8 to view the generated layout options. The user may further modify the bin attributes in the bin filters section 812 to match their desired bin attributes.

At step (iv), the user may browse the generated layouts 808 and choose a selected layout 810. At step (v), the user may access the first example bin selection user interface 900 of FIG. 9 to choose bins. For example, the user may choose one or more bins for each bin portion of the selected layout. Subsequent to the steps (i)-(v), the user may access the example report user interface 1000 of FIG. 10 to view the selected drawer layout, the selected bins, the project details, and the bin filters used when selecting the bins.

### Example 4

A fourth example uses a mathematical organization method. The fourth example includes the steps of: (i) obtaining drawer attributes including measurements from a user; (ii) selecting an organization method; (iii) obtaining a bin measurements (iv) obtaining desired bin attributes from a user; and (v) choosing bins favorites.

For example, to execute step (i), a user may access the example user input user interface 500 of FIG. 5 and provide drawer identifying information. The user may then access the example drawer attribute user interface 600 of FIG. 6 and provide spatial dimensions of the drawer in the drawer size field 602. At step (ii), the user may access the example organization method selection user interface 700 of FIG. 7. In the fourth example, the user selects the method “Mathematically” in the organization method selection field 702.

At step (iii), after the user selects the mathematical organization method, the system obtains desired bin measurements from the user. For example, the system may provide an interface for a user to provide desired bin measurements for one or more bins for a drawer. In some examples, the system may also obtain a desired drawer layout from the user which uses the bins having the provided measurements.

At steps (iv)-(v), the user may access a bin selection page to provide desired bin attributes and select bin favorites. For example the user may access the first example bin selection user interface 900 of FIG. 9. Each bin selection section 902 displayed on the first example bin selection user interface 900 may correspond to one of the one or more bins described by the user at step (iii). The system may select and display bin options 904 of bins having measurements equal to or slightly less than the bin measurements provided by the user. The user may then choose one or more bins for each bin selection section 902. Subsequent to the steps (i)-(v), the user may access the example report user interface 1000 of FIG. 10 to view the selected bins, the project details, and the bin filters used when selecting the bins.

### Conclusion

While preferred embodiments of the present disclosure have been shown and described herein, such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions may occur without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

It should be appreciated that 35 U.S.C. 112(f) or pre-AIA 35 U.S.C 112, paragraph 6 is not intended to be invoked unless the terms “means” or “step” are explicitly recited in the claims. Accordingly, the claims are not meant to be limited to the corresponding structure, material, or actions described in the specification or equivalents thereof.

1. A method for segmenting or organizing drawer space, the method comprising:
(a) determining one or more drawer attributes of at least one drawer;
(b) obtaining user criteria for segmenting or organizing a space within the at least one drawer;
(c) performing a search in a database and/or on a web based at least in part on the one or more drawer attributes and the user criteria, wherein the search is performed to identify one or more bins comprising one or more bin attributes that match the one or more drawer attributes and the user criteria;
(d) generating one or more layout configuration options of the one or more bins for segmenting or organizing the space within the at least one drawer; and
(e) providing the one or more layout configuration options on a graphical user interface (GUI) to a user,
wherein the GUI allows the user to select, manipulate, and/or modify the one or more layout configuration options, to achieve a target, desired or optimal layout configuration option for segmenting or organizing the space within the at least one drawer.

2. The method of claim 1, wherein the determining of the one or more drawer attributes of the at least one drawer is based on processing one or more images of the at least one drawer.

3. The method of claim 1, wherein (a)-(e) are performed using one or more computing systems.

4. The method of claim 3, wherein the one or more computing systems comprise one or more cloud computing systems.

5. The method of claim 1, wherein (a)-(e) are performed using one or more trained machine learning algorithms.

6. The method of claim 1, wherein the drawer attributes of the at least one drawer comprise spatial dimensions, structures, materials, colors, shapes, relationships to other drawers, or any combination thereof.
wherein the spatial dimensions comprise one dimension, two dimensions, or three dimensions of the at least one drawer, and
wherein the spatial dimensions comprise length, width, depth, or height of the at least one drawer.

7-8. (canceled)

9. The method of claim 6, wherein the structures comprise stackable storage drawers, rolling storage drawers, storage cabinets with drawers, storage dressers with drawers, beds with storage drawers, benches with drawers, filing cabinets drawers, furniture with drawers, any other system having drawers, or any combination thereof,
wherein the materials comprise woods, wood composites, metals, plastics, fabrics, or any combination thereof of the at least one drawer,
wherein the colors comprise wavelengths of infrared (IR), visible, ultraviolet (UV) wavelengths, or any combination thereof of the at least one drawer, and.
wherein the shapes comprise rectangular shapes, square shapes, triangular shapes, round shapes, or any combination thereof of the at least one drawer.

10-12. (canceled)

13. The method of claim 6, wherein the relationships to other drawers comprise drawers adjacent to other drawers, drawers above other drawers, drawers below other drawers, drawers behind other drawers, drawers in front of other drawers, or any combination thereof.

14. The method of claim 1, wherein the one or more bin attributes of the one or more bins comprise spatial dimensions, structures, materials, colors, shapes, relationships to other bins, cost, or any combination thereof,
wherein the spatial dimensions comprise one dimension, two dimensions, or three dimensions of the one or more bins, and
wherein the spatial dimensions comprise length, width, depth, or height of the one or more bins.

15-16. (canceled)

17. The method of claim 14, wherein the structures comprise bins for stackable storage drawers, rolling storage drawers, storage cabinets with drawers, storage dressers with drawers, beds with storage drawers, benches with drawers, filing cabinets drawers, furniture with drawers, any other system having drawers, or any combination thereof.

18. The method of claim 14, wherein the materials comprise woods, wood composites, metals, plastics, fabrics, or any combination thereof of the one or more bins,
wherein the colors comprise wavelengths of infrared (IR), visible, ultraviolet (UV) wavelengths, or any combination thereof of the one or more bins, and
wherein the shapes comprise rectangular shapes, square shapes, triangular shapes, round shapes, or any combination thereof of the one or more bins.

19-20. (canceled)

21. The method of claim 14, wherein the relationships to other bins comprise bins adjacent to other bins, bins above other bins, bins below other bins, bins behind other bins, bins in front of other bins, or any combination thereof.

22. The method of claim 1, wherein the generating in (d) further comprises using a trained machine learning (ML) model to determine the one or more layout configuration options, wherein the trained ML model has been trained using features associated with the drawer attributes, the bin attributes, the user criteria, or any combination thereof.

23. The method of claim 22, wherein the trained ML model has been trained with the features using supervised learning, unsupervised learning, semi-supervised learning, or any combination thereof.

24. The method of claim 23, wherein the supervised, the unsupervised, or the semi-supervised learning comprises linear regression, logistic regression, k-nearest neighbors, k-means clustering, support vector machines, artificial neural networks, decision trees, random forest, principal components analysis, or any combination thereof.

25. The method of claim 1, wherein the one or more layout configuration options depict at least one of:
spatial relationships of the one or more bins to the at least one drawer,
spatial relationships of the one or more bins to other bins of the one or more bins,
spatial relationships of the at least one drawer to other drawers of the at least one drawer.

26-27. (canceled)

28. The method of claim 1, wherein the one or more layout configuration options comprise a plurality of layout configuration options, the method further comprising:
(a) generating a recommendation comprising a recommended layout configuration selected from among the plurality of layout configuration options; and
(b) providing the recommended layout configuration on the GUI to the user.

29. The method of claim 1, wherein the one or more layout configuration options are provided in one or more reports to the user.

30. The method of claim 29, wherein the one or more reports comprise at least one of:
bin purchasing data associated with the one or more bins, wherein the data comprises purchasing sources, manufacturers, suppliers, distributers, prices, user reviews, or any combination thereof,
bin attributes data associated with the one or more bins, wherein the data comprises spatial dimensions, structures, materials, colors, shapes, cost, or any combination thereof,
bin comparison data associated with the one or more bins, wherein the data compares the one or more bins between different purchasing sources, manufacturers, suppliers, distributers, or any combination thereof, and
custom bin manufacturing data associated with the one or more bins, wherein the data comprises one or more manufacturers that can manufacture the one or more bins.

31-33. (canceled)

34. The method of claim 29, wherein the one or more reports are shared with one or more users other than the user.

35. The method of claim 1, wherein the user criteria comprises one or more criteria associated with the one or more drawer attributes, the one or more bin attributes, or any combination thereof.

36. A computer-implemented system comprising: a digital processing device comprising at least one processor, an operating system configured to perform executable instructions, a memory, and a computer program including instructions executable by the digital processing device to create an application for segmenting or organizing drawer space, the application comprising:
(a) a module determining one or more drawer attributes of at least one drawer;
(b) a module obtaining user criteria for segmenting or organizing a space within the at least one drawer;
(c) a module performing a search in a database and/or on a web based at least in part on the one or more drawer attributes and the user criteria, wherein the search is performed to identify one or more bins comprising one or more bin attributes that match the one or more drawer attributes and the user criteria;
(d) a module generating one or more layout configuration options of the one or more bins for segmenting or organizing the space within the at least one drawer; and
(e) a module providing the one or more layout configuration options on a graphical user interface (GUI) to a user, wherein the GUI allows the user to select, manipulate, and/or modify the one or more layout configuration options, to achieve a target, desired or optimal layout configuration option for segmenting or organizing the space within the at least one drawer.

37. A non-transitory computer-readable storage media encoded with a computer program including instructions executable by a processor to create an application for segmenting or organizing drawer space, the application comprising:
(a) a module determining one or more drawer attributes of at least one drawer;
(b) a module obtaining user criteria for segmenting or organizing a space within the at least one drawer;
(c) a module performing a search in a database and/or on a web based at least in part on the one or more drawer attributes and the user criteria, wherein the search is performed to identify one or more bins comprising one or more bin attributes that match the one or more drawer attributes and the user criteria;
(d) a module generating one or more layout configuration options of the one or more bins for segmenting or organizing the space within the at least one drawer; and
(e) a module providing the one or more layout configuration options on a graphical user interface (GUI) to a user, wherein the GUI allows the user to select, manipulate, and/or modify the one or more layout configuration options, to achieve a target, desired or optimal layout configuration option for segmenting or organizing the space within the at least one drawer.
